(19) United States
(12) Patent Application Publication
(10) Pub. No.: US 2016/0342311 A1
(43) Pub. Date: Nov. 24, 2016

(54) TIMER DISPLAY AND METHODS OF COMMUNICATION BETWEEN THE TIMER DISPLAY AND A MOBILE DEVICE

(71) Applicant: 1804282 ONTARIO LIMITED DBA GYMNEXT, Tiny (CA)

(72) Inventor: Duane HOMICK, Tiny (CA)

(21) Appl. No.: 15/160,077

(22) Filed: May 20, 2016

Related U.S. Application Data
(60) Provisional application No. 62/164,962, filed on May 21, 2015.

(51) Int. Cl. G06F 3/0484; H04W 4/00; G06F 3/16; H04W 76/06; G06F 3/0481; H04W 76/02; H04W 40/02

(52) U.S. Cl. CPC G06F 3/04842; H04W 76/023; H04W 4/008; H04W 40/02; H04W 76/06; G06F 3/0481; G06F 3/167; G06F 3/04847

(57) ABSTRACT

There is provided a timer display and a method of communication between the timer display and a mobile device running a timer application. The method comprises: receiving a selection of a schedule at the mobile device, the selection received through a graphical user interface (GUI) associated with the timer application; receiving through the GUI a connection input to connect to the timer display; connecting the mobile device directly to the timer display using a two-way data communication protocol, the timer display comprising a plurality of multi-segment light emitting diode (LED) digits; transmitting from the timer display to the mobile device a confirmation of connection and a status of the timer display; and controlling the timer display by the mobile device based on the schedule and the status of the timer display.

### CROSS-REFERENCE TO RELATED APPLICATIONS

This application claims priority from U.S. Provisional Patent Application No. 62/164,962 filed on May 21, 2015, which is incorporated herein by reference in its entirety.

### FIELD

The present specification relates to timer displays, and in particular to wall-mountable timer displays that are remotely controllable.

### BACKGROUND

There exist devices for digitally displaying exercise schedules, for example interval time periods. Some of these devices are LED digital displays, which can be mounted on a wall so that they may be viewed from a distance. A subset of these devices is controlled by infrared (IR) remote controls. Such IR remote controls have many limitations. For example, IR remote controls require a line of slight between the control and the device. In addition, these remotes are typically only transmitters, which means that the device cannot communicate back to the remote. Partly due to these communication limitations, such IR remote controls attempt to offer multiple programming functions to the user but are limited by the number of buttons on the remote control and by the lack of visual feedback given to the user while they program their desired exercise schedule. Further limitations of IR remote controls include: their relatively short range, and the difficulty in encoding data in transmission and/or in sending multiple commands in one transmission.

In recent years, mobile devices have become able to offer enhanced control of physical display and control systems centering around a simpler interface and larger control radius. Turning on and off light bulbs, and controlling home thermostats are examples of mobile devices being used to control objects in the physical world.

Wireless sensors and wearable devices have offered new capabilities to mobile devices by allowing the collection of real world information. These sensors and wearables can be used to track biometric data such as heart rate, blood oxygen levels, etc. They can also be used to track activity, distances and displacement in a three dimensional space. The sensors can feed the data into a mobile device that interprets the raw information and makes decisions based on that information.

Moreover, controlling real world displays and controls with a mobile device attached to wireless sensors and wearable devices offers additional possibilities not attainable with the manual approach to controlling displays and controls. For example, a light bulb is not just turned on/off, but can be programmed to turn on/off at certain times of the day. A thermostat can control the temperature of the room based on a reading of the body temperatures of everyone in the room. This level of sophistication has not been used in exercise timer displays such as interval time trackers and displays.

### SUMMARY

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, ZZ, and the like). Similar logic can be applied for two or more items in any occurrence of “at least one . . . ” and “one or more . . . ” language.

An aspect of the present specification provides a method of communication between a timer display and a mobile device running a timer application, the method comprising: receiving a selection of a schedule at the mobile device, the selection received through a graphical user interface (GUI) associated with the timer application; receiving through the GUI a connection input to connect to the timer display; connecting the mobile device directly to the timer display using a two-way data communication protocol, the timer display comprising a plurality of multi-segment light emitting diode (LED) digits; transmitting from the timer display to the mobile device a confirmation of connection and a status of the timer display; and controlling the timer display by the mobile device based on the schedule and the status of the timer display. After the connecting, the communication between the timer display and the mobile device is in the form of one or more data packets formatted according to the two-way data communication protocol.

The two-way data communication protocol can comprise a wireless communication protocol configured for near real-time, non-line-of-sight communication between the timer display and the mobile device, the communication having a latency less than about 3 s.

The two-way data communication protocol can comprise Bluetooth™.

The multi-segment LED digits can have a height greater than or equal to about 1 inch.

The status can comprises one of: an unavailability indication associated with the timer display actively counting time or the timer display being paused while displaying non-default start values; and an availability indication associated with the timer display being in a state other than actively counting time and displaying non-default start values.

When the status comprises the unavailability indication, the status can further comprise a timer display schedule identifier.

The method can further comprise: after the connecting and before the transmitting, the mobile device transmitting to the timer display: a seed for a current chronological clock, and an audio state and an increment-decrement clock direction associated with the timer application; and the timer display storing in a memory onboard the timer display the seed, the audio state, and the increment-decrement clock direction.

The controlling can comprise: if the status comprises the availability indication: transmitting the schedule from the mobile device to the timer display; storing the schedule in the memory; displaying on the timer display an initial state associated with the schedule in a paused state; receiving through the GUI a start input to start counting time according to the schedule; transmitting the start input from the mobile device to the timer display; and displaying on the timer display time being counted according to the schedule and the increment-decrement clock direction. If the status comprises the unavailability indication: displaying a prompt on the mobile device requesting input whether to force synch the timer display with the timer application, the prompt displayed through the GUI associated with the timer application; receiving through the GUI a force synch input in response to the prompt; and if the force synch input is affirmative: transmitting from the mobile device to the timer display a request to pause and reset the timer display; pausing and resetting the timer display; transmitting the schedule from the mobile device to the timer display; storing the schedule in the memory; displaying on the timer display the initial state associated with the schedule in a paused state; receiving through the GUI the start input to start counting time according to the schedule; transmitting the start input from the mobile device to the timer display; and displaying on the timer display time being counted according to the schedule and the increment-decrement clock direction; and if the force synch input is negative: disconnecting the mobile device from the timer display.

The displaying on the timer display time being counted can further comprise emitting one or more sounds from the timer display according to the schedule and the audio state.

The method can further comprise: after displaying on the timer display time being counted according to the schedule and the increment-decrement clock direction, transmitting at predetermined intervals from the mobile device to the timer display a current time as being counted by the timer application to keep the timer display synchronized with the timer application.

The predetermined intervals can each comprise about 60 seconds.

The method can further comprise, after receiving the selection of the schedule and before receiving the connection input: receiving through the GUI a start input to start counting time according to the schedule; and displaying on the mobile device time being counted by the timer application according to the schedule. The controlling can comprise: if the status comprises the availability indication: transmitting the schedule from the mobile device to the timer display; storing the schedule in the memory; transmitting a current time count seed from the mobile device to the timer display, the transmitting affected at a predetermined lead time prior to a smallest time increment displayable on the timer display; and displaying on the timer display time being counted starting at the current time count seed and according to the schedule and the increment-decrement clock direction. If the status comprises the unavailability indication: displaying a prompt on the mobile device requesting input whether to force synch the timer display with the timer application, the prompt displayed through the GUI associated with the timer application; receiving through the GUI a force synch input in response to the prompt; and if the force synch input is affirmative: transmitting from the mobile device to the timer a request to pause and reset the timer display; pausing and resetting the timer display; transmitting the schedule from the mobile device to the timer display; storing the schedule in the memory; transmitting the current time count seed from the mobile device to the timer display, the transmitting affected at the predetermined lead time prior to the smallest time increment displayable on the timer display; and displaying on the timer display time being counted starting at the current time count seed and according to the schedule and the increment-decrement clock direction; and if the force synch input is negative: disconnecting the mobile device from the timer display.

The predetermined lead time can comprise about 10 ms and the smallest time increment displayable by the timer display can comprise about 1 s.

The method can further comprise, after receiving the selection of the schedule and before receiving the connection input: receiving through the GUI a start input to start counting time according to the schedule; and displaying on the mobile device time being counted by the timer application according to the schedule. The controlling can comprise: if the status comprises the availability indication: transmitting the schedule from the mobile device to the timer display; storing the schedule in the memory; transmitting a current time count seed from the mobile device to the timer display, the transmitting affected at a predetermined lead time prior to a smallest time increment displayable on the timer display; and displaying on the timer display time being counted starting at the current time count seed and according to the schedule and the increment-decrement clock direction. If the status comprises the unavailability indication: comparing at the mobile device the timer display schedule identifier received from the timer display with a timer application schedule identifier stored on the mobile device to determine whether the timer display and the timer application are counting time in synch and according to the schedule; if the timer display schedule identifier is the same as the timer application schedule identifier: the mobile device remaining connected to the timer display; and if the timer display schedule identifier is different than the timer application schedule identifier: displaying a prompt on the mobile device requesting input whether to force synch the timer display with the timer application, the prompt displayed through the GUI associated with the timer application; receiving through the GUI a force synch input in response to the prompt; and if the force synch input is affirmative: transmitting from the mobile device to the timer a request to pause and reset the timer display; pausing and resetting the timer display; transmitting the schedule from the mobile device to the timer display; storing the schedule in the memory; transmitting the current time count seed from the mobile device to the timer display, the transmitting affected at the predetermined lead time prior to the smallest time increment displayable on the timer display; and displaying on the timer display time being counted starting at the current time count seed and according to the schedule and the increment-decrement clock direction; and if the force synch input is negative: disconnecting the mobile device from the timer display.

The method can further comprise: after the transmitting and before the controlling: transmitting the schedule from the mobile device to the timer display; storing the schedule in a memory onboard the timer display; displaying on the timer display an initial state associated with the schedule in a paused state; receiving through the GUI another selection of another schedule; transmitting the other schedule from the mobile device to the timer display; storing the other schedule in the memory; and displaying on the timer display an initial state associated with the other schedule in a paused state; wherein the controlling the timer display by the mobile device comprises controlling the timer display by the mobile device based on the other schedule and the status of the timer display.

The method can further comprise, before the controlling: receiving through the GUI an input to display sensor data on the timer display for a given display duration at one or more predetermined display times; and wherein the controlling can comprise: at each predetermined display time receiving the sensor data at the mobile device; transmitting the sensor data from the mobile device to the timer display; clearing one or more portions of the timer display needed to display the sensor data; and displaying the sensor data on the timer display for the given display duration.

According to another aspect of the present specification, there is provided a timer display comprising: a plurality of multi-segment LED digits having a height greater than or equal to about 1 inch; a sound generator; a processor configured to drive the multi-segment LED digits and the sound generator; a memory in communication with the processor; and a communication interface in communication with the processor, the communication interface configured for two-way data communication. The timer display is configured to: connect directly to a mobile device running a timer application, the connection via the communication interface and using a two-way data communication protocol; receive a schedule from the mobile device via the communication interface, the schedule received in the form of one or more data packets formatted according to the two-way data communication protocol, a selection of the schedule received through a GUI associated with the timer application; store the schedule in the memory; transmit via the communication interface to the mobile device a confirmation of connection and a status of the timer display, the confirmation and the status transmitted in the form of one or more data packets formatted according to the two-way data communication protocol; receive via the communication interface one or more control commands from the mobile device, the control commands in the form of one or more data packets formatted according to the two-way data communication protocol; and control via the processor one or more of the multi-segment LED digits and the sound generator according to the control commands.

The two-way data communication protocol can comprise a wireless communication protocol configured for near real-time, non-line-of-sight communication between the timer display and the mobile device, the communication having a latency less than about 3 s.

The two-way data communication protocol comprises Bluetooth™.

According to another aspect of the present specification, there is provided a method of communication between a first mobile device running a timer application, a first timer display, a second mobile device running the timer application, and a second timer display, the method comprising: receiving a selection of a schedule at the first mobile device, the selection received through a GUI associated with the timer application running on the first mobile device; receiving through the GUI a connection input to connect to the first timer display; connecting the first mobile device directly to the first timer display using a two-way data communication protocol; receiving through the GUI a further connection input to connect to the second timer display; connecting the first mobile device to the second mobile device; measuring a communication lag between the first mobile device and the second mobile device; connecting the second mobile device directly to the second timer display using the two-way data communication protocol; transmitting the schedule from the first mobile device to the first timer display; transmitting the schedule from the first mobile device to the second timer display via the second mobile device; displaying on the first timer display and the second timer display an initial state associated with the schedule in a paused state; receiving through the GUI a start input to start counting time according to the schedule; transmitting a modified start input from the first mobile device to the first timer display and to the second timer display via the second mobile device, the modified start input comprising the start input delayed by a time period equal to or greater than the communication lag; and displaying on the first timer display and the second timer display time being counted according to the schedule.

### BRIEF DESCRIPTION OF THE DRAWINGS

Preferred implementations of the present specification will now be described, by way of example only, with reference to the attached Figures, wherein:

FIG. 1 shows a schematic system diagram of a mobile device in communication with timer display, according to non-limiting implementations.

FIG. 2 shows a functional block diagram of a timer display, according to non-limiting implementations.

FIG. 3 shows a cross-section of a timer display, according to non-limiting implementations.

FIG. 4 shows a functional circuit diagram of a timer display, according to non-limiting implementations.

FIG. 5 shows a shows a schematic of the multi-segment LED digital display circuit, for the specific example of seven-segment LED display digits of a timer display, according to non-limiting implementations.

FIG. 6 shows a mockup depicting a control interface that may be displayed on a wearable smart watch device, according to non-limiting implementations.

FIG. 7 shows a top perspective view of a timer display, according to non-limiting implementations.

FIG. 8 shows a bottom perspective view of the timer display of FIG. 7.

FIG. 9 shows a left side elevation view of the timer display of FIG. 7.

FIG. 10 shows a front side elevation view of the timer display of FIG. 7.

FIG. 11 shows a right side elevation view of the timer display of FIG. 7.

FIG. 12 shows a back side elevation view of the timer display of FIG. 7.

FIG. 13 shows a top plan view of the timer display of FIG. 7.

FIG. 14 shows a bottom plan view of the timer display of FIG. 7.

FIG. 15 shows a top perspective view of a bracket, according to non-limiting implementations.

FIG. 16 shows a side elevation view of the bracket of FIG. 15.

FIG. 17 shows a screen shot of a timer application, according to non-limiting implementations.

FIG. 18 shows another screen short of the timer application of FIG. 17.

FIG. 19 shows another screen short of the timer application of FIG. 17.

FIG. 20 shows another screen short of the timer application of FIG. 17.

FIG. 21 shows another screen short of the timer application of FIG. 17.

FIG. 22 shows another screen short of the timer application of FIG. 17.

FIG. 23 shows another screen short of the timer application of FIG. 17.

FIG. 24 shows another screen short of the timer application of FIG. 17.

FIG. 25 shows another screen short of the timer application of FIG. 17.

FIG. 26 shows another screen short of the timer application of FIG. 17.

FIG. 27 shows another screen short of the timer application of FIG. 17.

FIG. 28 shows a flow chart depicting steps of a method of communication between a mobile device and a timer display, according to non-limiting implementations.

FIG. 29 shows a flow chart depicting steps of a method of communication between a mobile device and a timer display, according to non-limiting implementations.

FIG. 30 shows a flow chart depicting steps of a method of communication between a mobile device and a timer display, according to non-limiting implementations.

FIG. 31 shows a flow chart depicting steps of a method of communication between a mobile device and a timer display, according to non-limiting implementations.

FIG. 32 shows a flow chart depicting steps of a method of communication between a mobile device and a timer display, according to non-limiting implementations.

FIG. 33 shows a flow chart depicting steps of a method of communication between a mobile device and a timer display, according to non-limiting implementations.

FIG. 34 shows a flow chart depicting steps of a method of communication between a mobile device and a timer display, according to non-limiting implementations.

FIG. 35 shows a flow chart depicting steps of a method of communication between a mobile device and a timer display, according to non-limiting implementations.

FIG. 36 shows a flow chart depicting steps of a method of communication between a mobile device and a timer display, according to non-limiting implementations.

FIG. 37 shows a flow chart depicting steps of a method of communication between a mobile device and a timer display, according to non-limiting implementations.

FIG. 38 shows a schematic system diagram of two sets of mobile devices in communication with two sets of timer displays respectively, according to non-limiting implementations.

FIG. 39 shows a flow chart depicting steps of a method of communication between two sets of mobile devices and two sets of timer displays, according to non-limiting implementations.

FIG. 40 shows a flow chart depicting steps of a method of communication between two sets of mobile devices and two sets of timer displays, according to non-limiting implementations.

### DETAILED DESCRIPTION

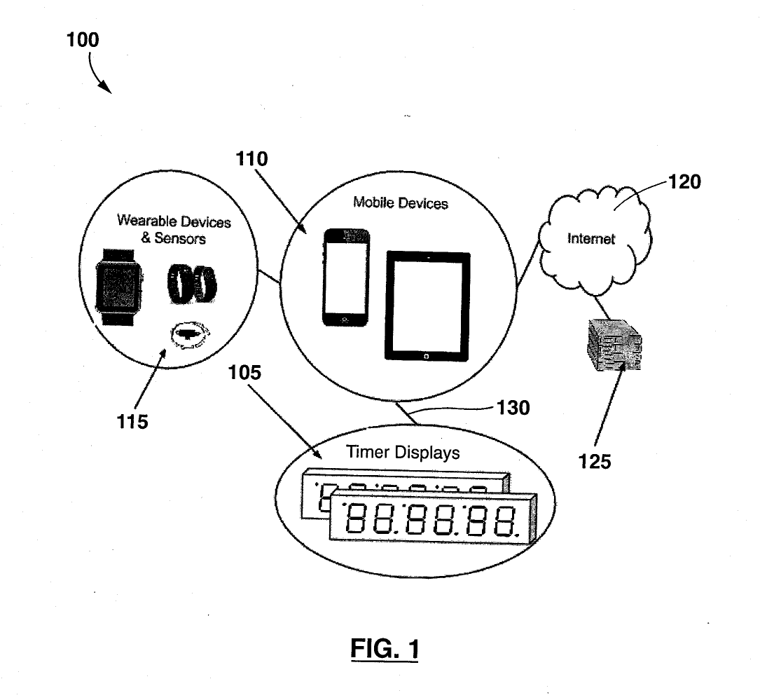

The present specification seeks to provide a sophisticated mechanism for controlling an exercise schedule timer display from a mobile device, while possessing the ability to incorporate data collected from wearable devices and wireless sensors. FIG. 1 shows system 100 comprising one or more digital timer displays 105 directly connected to one or more mobile devices 110 using a two-way data communication protocol 130. Mobile devices 110 can also connect to wearable devices and/or sensors 115, such as smart watches, activity trackers, and other suitable wearables and sensors. Mobile devices 110 can also connect to a network 120, such as the Internet. Through network 120, mobile devices 110 can connect to a server 125 hosting content and/or applications.

While FIG. 1 shows exemplary mobile devices 110 in the form of a smartphone and a tablet, it is contemplated that any suitable mobile device can be used so long as the mobile device is capable of direct two-way data communication with timer displays 105. In addition, while FIG. 1 shows timer displays 105 connecting to wearable devices and sensors 115 and network 120 via mobile devices 110, it is also contemplated that timer displays 105 can connect directly to one or more of wearable devices and sensors 115 and network 120.

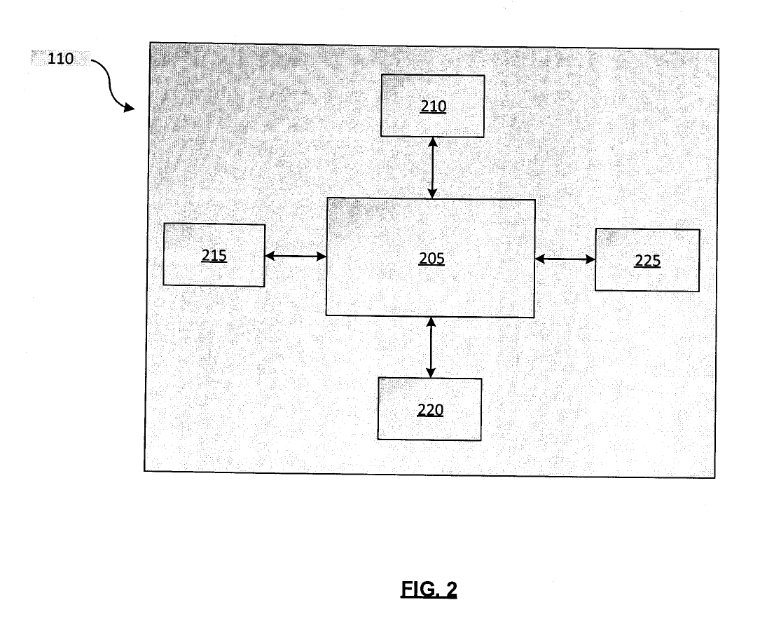

FIG. 2 shows a functional block representation of an exemplary timer display 105. Timer display 105 comprises a processor 205, a plurality of multi-segment light emitting diode (LED) digits 215, and a sound generator 215. Processor 205 is configured to drive the multi-segment LED digits 210 and the sound generator 215. Timer display 105 also comprises a communication interface 220 and an on-board memory 225, both also in communication with processor 205. Communication interface 220 is configured for two-way data communication.

It is contemplated that multi-segment LED digits 210 can comprise any suitable number of segments including, but not limited to, seven segments and fourteen segments. It is also contemplated that timer display 105 can comprise an LED matrix or any other suitable emissive or reflective display instead of and/or in addition to the multi-segment LED digits 210. Sound generator 215 can comprise a buzzer, a bell, a speaker, a horn, or any other suitable sound generator. Communication interface 220 can comprise a wired or a wireless communication interface.

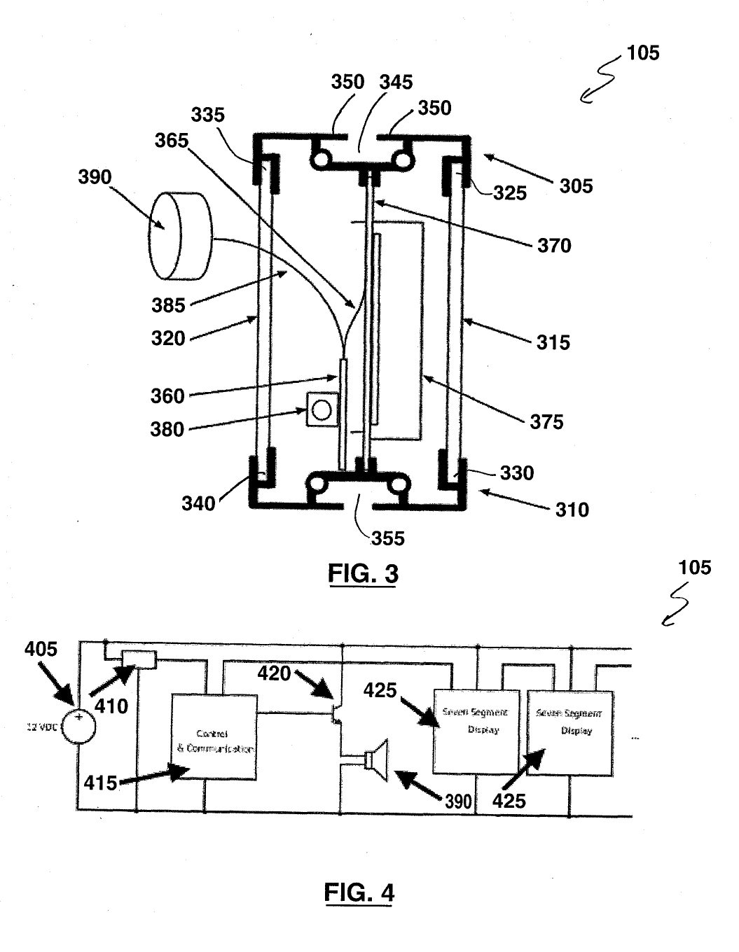

FIG. 3 shows a cross-section of an exemplary timer display 105, comprising a top rail 305, a bottom rail 310, a front panel 315, and a back panel 320. Top rail defines grooves 325 and 335. Bottom rail defines grooves 330 and 340. Front panel 315 is received into groove 325 and groove 330. Back panel 320 is received into groove 335 and groove 340. Top rail 305 furthermore comprises a trench 345 running along the length of top rail 305. Trench 345 comprises overhanging lips 350 extending from the edges towards the middle of trench 345. Bottom rail 310 similarly comprises a trench 355 running along its length, which trench 355 comprises overhanging lips similar to overhanging lips 350.

Timer display 105 also comprises controller circuit board 360 connected via cable 365 to multi-segment LED digits circuit board 370. Controller circuit board 360 is also connected via cable to 385 to buzzer 390. Controller circuit board 360 comprises a processor which can be an example of processor 205 shown in FIG. 2. Controller circuit board 360 can also comprise on-board memory (not shown) and/or be connected to a separate memory (not shown) inside timer display 105. This on board and/or separate memory can be an example of memory 225. Timer display 105 can also comprise a communication interface, not visible in FIG. 3. In addition, buzzer 390 can be an example of sound generator 215.

Multi-segment LED digits 375 can be connected to multi-segment LED digits circuit board 370. Multi-segment LED digits 375 can be an example of multi-segment LED digits 210. Moreover, a power adaptor jack 380 can be connected to controller circuit board 360, to power all the electronic components inside timer display 105. Power adaptor jack 380 can be connectable to a DC Wall Adapter.

As multi-segment LED digits 375 are viewed through front panel 315, front panel 315 is partially or fully transparent or translucent to human visible light. Front panel 315 can comprise materials including, but not limited to, glass and plastics. Front Panel 315 can be tinted to block ambient light while allowing bright light from the multi-segment LED digits 375 to be seen. Back panel 320 can be made of any suitable material including, but not limited to, wood, plastic, metal, and glass. Top rail 305 and bottom rail 310 can be made of any suitable material including, but not limited to, metal and plastics.

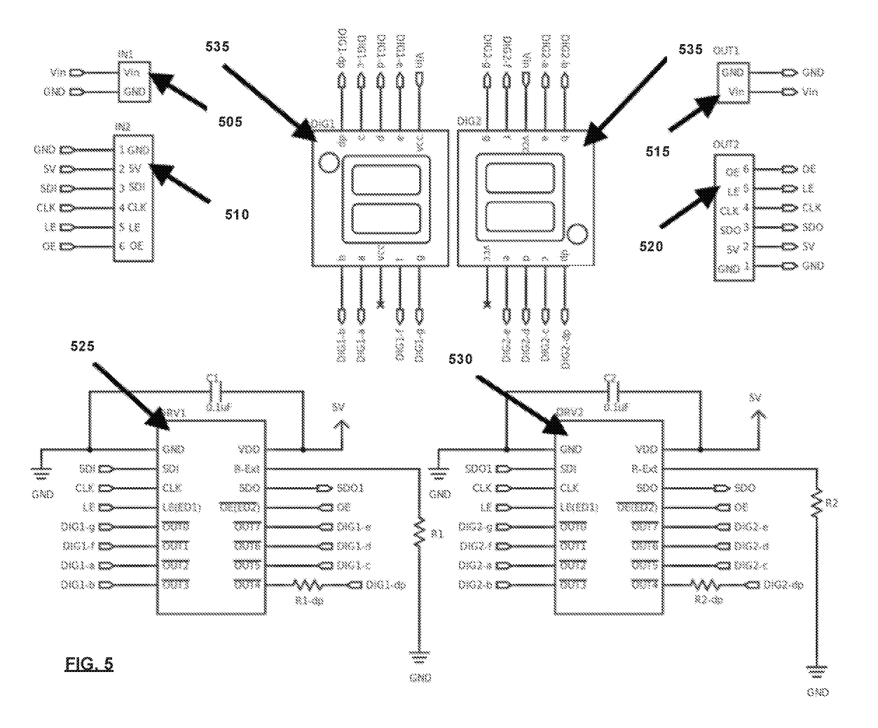

FIG. 4 shows a functional circuit diagram of an exemplary timer display 105. In this exemplary implementation, a 12V DC power supply 405 provides power to the control circuit and connected circuits and components. A voltage regulator 410 reduces voltage for connected integrated circuits. A control & communication module 415 receives reduced voltage input and manages buzzer 390 via a transistor 420 and daisy-chained multi-segment control circuits 425. Control & communication module 415 also receives wireless instructions. This allows control & communication module 415 to turn buzzer 390 on/off and to turn specific segments of the multi-segment LEDs digits 375 (shown in FIG. 3) on/off based on internal or external logic.

FIG. 5 shows a schematic of the multi-segment LED digital display circuit, for the specific example of seven-segment LED display digits. Power arrives at the circuit via Power In Header 505 and the signal arrives at the circuit via Signal In Header 510. Power is carried to the Seven Segment Display LED digits 535 and to the Power Out Header 515. Signal is carried to Primary Constant Current Driver 525 which is then linked to Secondary Constant Current Driver 530 and then linked to Signal Out Header 520. Constant Current Drivers are connected to Seven Segment Display LED digits allowing the input signal to control which part(s) of the Seven Segment Display are lit.

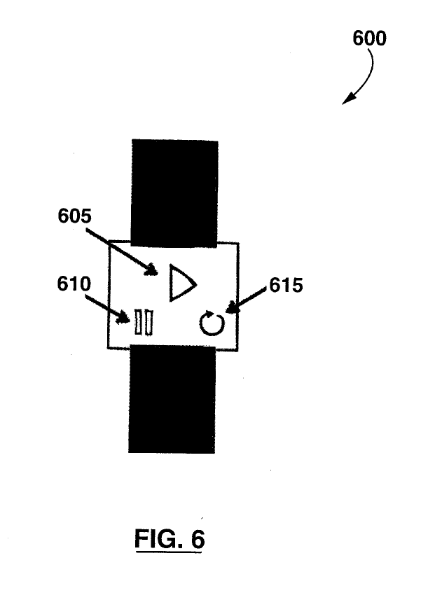

FIG. 6 depicts a mockup showing a control interface that may be displayed on a wearable smart watch device 600. The interface can contain timer controls including a Start Button 605, a Pause Button 610, and a Reset Button 615. The smart watch sends the commands received through the interface to timer displays 105 either directly or via mobile devices 110 (shown in FIG. 1).

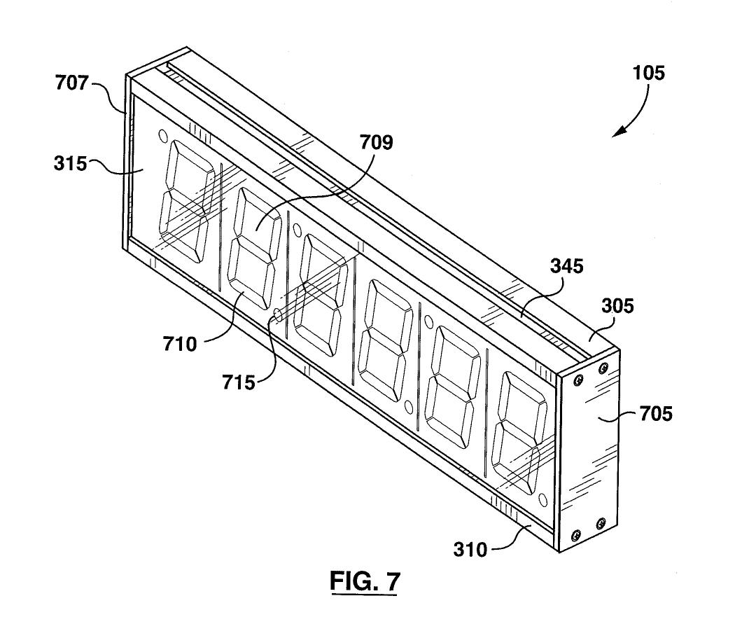

FIG. 7 shows a top perspective view of an exemplary timer display 105, comprising top rail 305 having trench 345, bottom rail 310, a first side panel 705, a second side panel 707, and front panel 315. First and second side panels 705, 707 can comprise any suitable material including, but not limited to plastic, metal, and wood. In this implementation, the multi-segment LED digits comprise seven-segment LED digits 709, each comprising seven LED segments 710. Each segment 710 can comprise one or more LED light emitters. Digits 709 can also comprise additional visual components such as dot and/or decimal 715 which can also comprise one or more LED light emitters.

As shown in FIG. 7, timer display 105 comprises six seven-segment LED digits 709. However, it is contemplated that in other implementations, the timer display can comprise any number of multi-segment LED digits. In addition, in FIG. 7, the six seven-segment LED digits 709 are shown as being arranged side-by-side. However, it is also contemplated that in other implementations the multi-segment LED digits can be arranged in any suitable geometry, including, but not limited to, one on top of another, a two-dimensional array, and diagonally.

In some implementations, the multi-segment LED digits can have a height of greater than or equal to about 1 inch. In other implementations, the multi-segment LED digits can have a height of greater than to equal to about 2.3 inches. In yet other implementations, the multi-segment LED digits can have a height of greater than to equal to about 4 inches. These digit sizes/heights can allow the information displayed on the timer display to be easily legible from distances of about two meters or more. This in turn, can allow the timer display to be legible by average unaided human vision when the timer display is mounted on a wall of or otherwise placed in a space that would be large enough for one or more people to comfortably exercise. In some implementations, the timer display can be supported on a stand or tripod.

It is contemplated that the timer display can be used in a variety of settings including, but not limited to, home and commercial gyms, indoor and outdoor tracks, race courses, and stadiums, and examination invigilation rooms. In stadiums, the timer display can be used as the score board, shot clock, penalty clock, or any other timer that needs to be visible to multiple viewers from a distance. In race tracks and race courses, the timer display can be used in various applications, including but not limited to, as the race timer or the swimming timer.

In addition to relatively large LED digit sizes, the sound generator in the timer display can be loud enough to be heard in potentially large and noisy spaces such as commercial gyms and indoor and outdoor tracks, race courses, and stadiums. In some implementations, the sound generator can comprise an about 85 db buzzer. In other implementations, the sound generator can comprise an about 95 db buzzer.

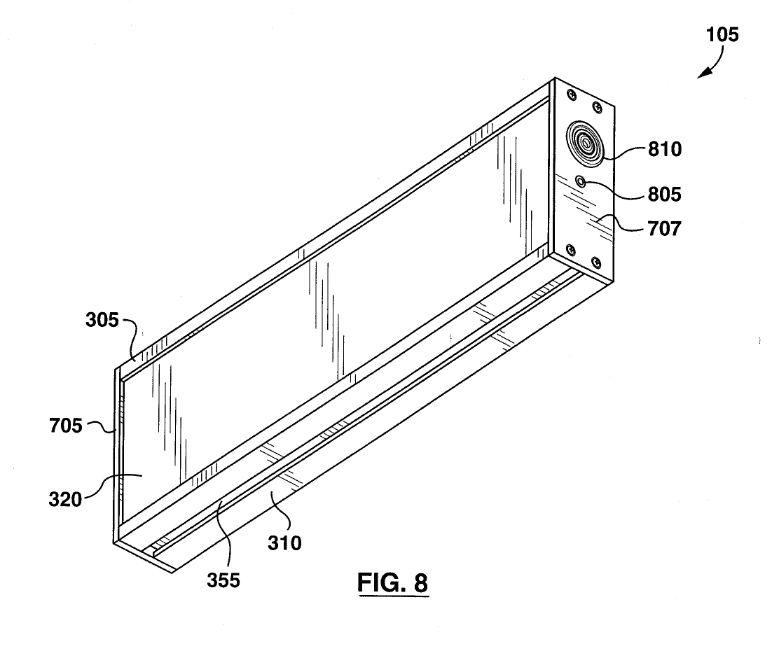

FIG. 8 shows a bottom perspective view of timer display 105 comprising top rail 305, bottom rail 310 having trench 355, first side panel 705, second side panel 707, and back panel 320. Second side panel 707 comprises a power jack inlet 805 and a buzzer outlet 810.

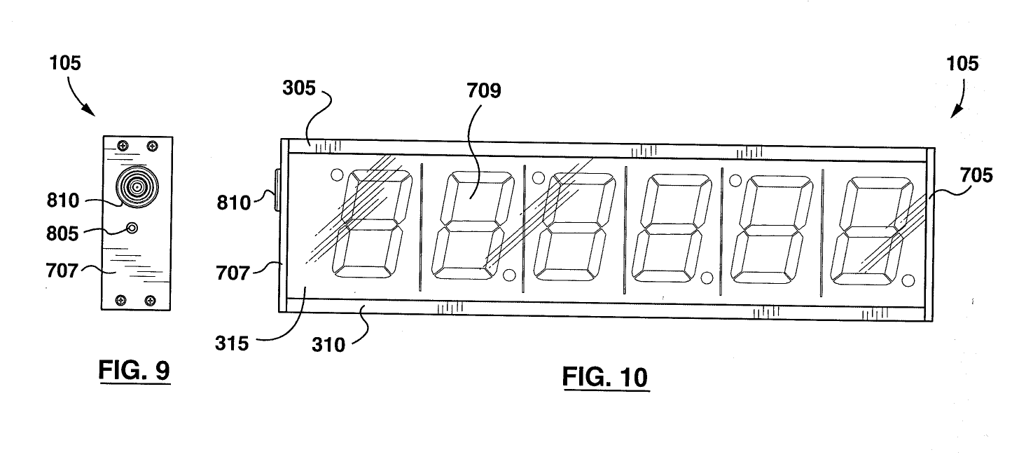

FIG. 9 depicts a side elevation view of timer display 105, showing second side panel 707, its power jack inlet 805 and buzzer outlet 810, and the four screws that secure second side panel 707 to the top and bottom rails (not shown). FIG. 10 depicts a front elevation view of timer display 105, showing top rail 305, bottom rail 310, first side panel 705, and second side panel 707 having buzzer outlet 810. Seven segment LED digits 709 are visible through front panel 315.

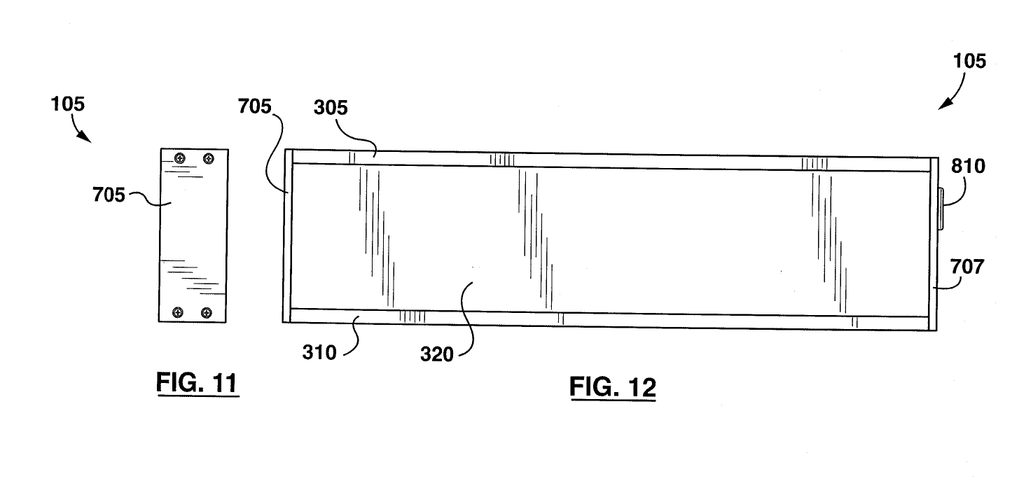

FIG. 11 shows a side elevation view of timer display 105, showing first side panel 705, and the four screws that secure first side panel 705 to the top and bottom rails (not shown). FIG. 12 depicts a back elevation view of timer display 105, showing top rail 305, bottom rail 310, first side panel 705, and second side panel 707 having buzzer outlet 810. Back panel 320 is also shown.

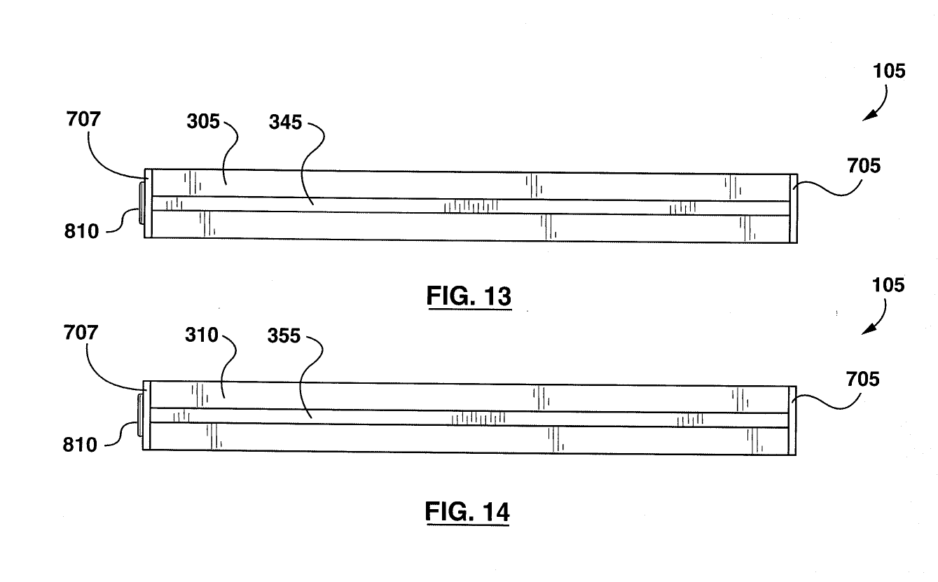

FIG. 13 depicts a top plan view of timer display 105, showing top rail 305 and its trench 345, first side panel 705, and second side panel 707 having buzzer outlet 810. FIG. 14 depicts a bottom plan view of timer display 105, showing bottom rail 310 and its trench 355, first side panel 705, and second side panel 707 having buzzer outlet 810.

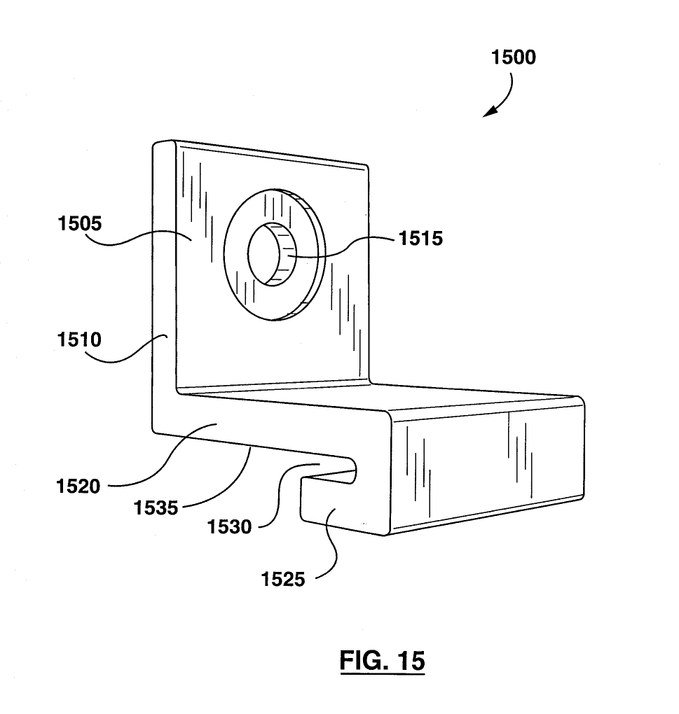

FIG. 15 shows a top perspective view of a bracket 1500 for mounting timer display 105 to a wall or other substantially upright substrate. Bracket 1500 comprises an L-shaped body 1505 comprising a first segment 1510 having a screw hole 1515 and a second segment 1520 terminating in a turned-over end 1525. Turned-over end 1525 cooperates with surface 1535 of second segment 1520 to define groove 1530. When bracket 1500 is used for mounting timer display 105, overhanging lip 350 (not shown in FIG. 15, but shown in FIG. 3) can be received in groove 1530, with surface 1535 positioned against and/or near top rail 305 (not shown in FIG. 15, but shown in FIG. 3).

In addition to cooperating with bracket 1500 to allow for mounting timer display 105 to an upright substrate, trench 345 can also allow for multiple timer displays 105 to be stacked one on top of another, with the aid of a cross-tie (not shown) that engages one trench of a first timer display and a corresponding trench of a second timer display, thereby connecting and securing the two timer displays in a stacked configuration.

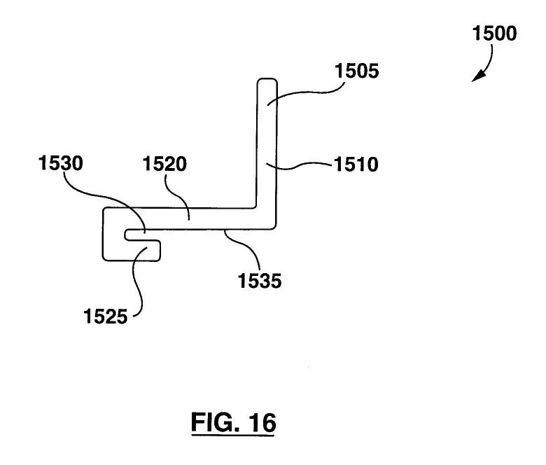

FIG. 16 depicts a side view of bracket 1500, showing L-shaped body 1505 having first segment 1510 and second segment 1520 terminating in turned-over end 1525. The turned-over end 1525 cooperates with surface 1535 to define groove 1530.

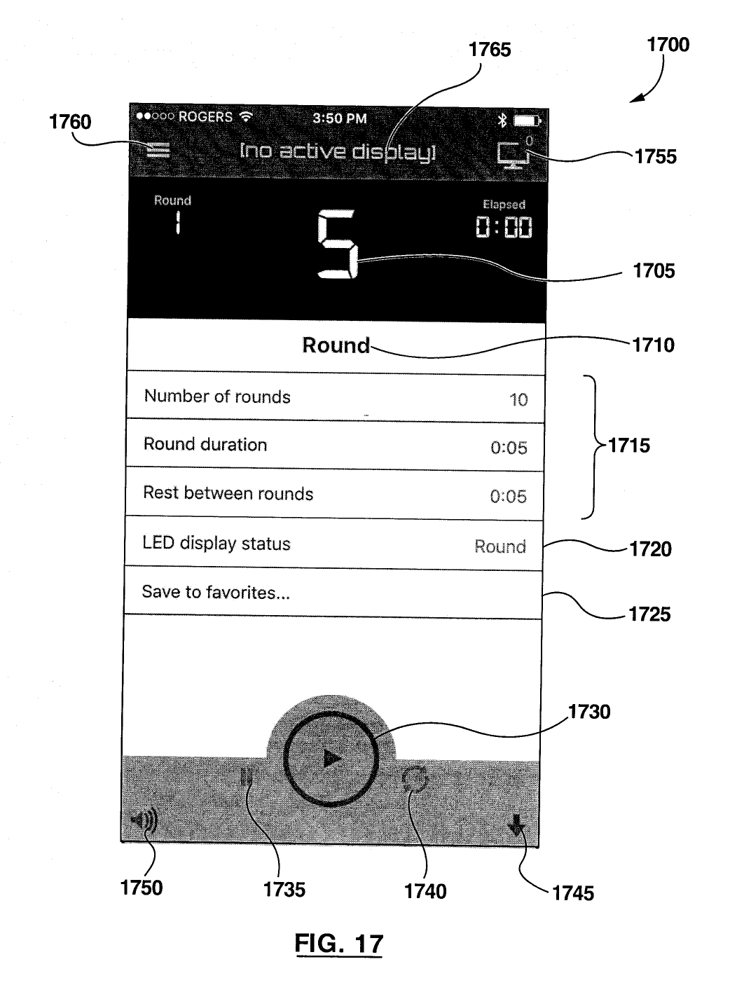

Turning now to the timer application, FIG. 17 shows a screenshot 1700 generated by an exemplary timer application running on mobile device 110 (shown in FIG. 1). Timer application is used to interface with and control timer display 105. Screenshot 1700 shows application timer 1705 showing details of the currently selected exercise schedule, including the number of rounds and the time remaining and/or elapsed. Screenshot 1700 also includes a schedule type 1710, and schedule details 1715. Timer display current schedule 1720 indicates what type of schedule would be shown on timer display 105 if one were connected to mobile device 110. An option to save favorite schedules 1725 is also provided, to allow saving and quick future access to favorite schedules.

A start button 1730 is provided and is configured to receive input to start running the schedule in the application timer 1705 and also in timer display 105 if one is connected to mobile device 110. A pause button 1735 is also provided and is configured to receive input to pause the running schedule in the application timer 1705 and also in timer display 105 if one is connected to mobile device 110. A reset button 1740 is also provided and is configured to receive input to reset the application timer 1705 and also timer display 105 if one is connected to mobile device 110.

A mute button 1750 is provided and is configured to receive input to mute any audible prompts from the timer application. An increment-decrement direction button 1745 is also provided and is configured to receive input selecting whether time periods in the schedule are incremented or decremented in application timer 1705 and also in timer display 105 if one is connected to mobile device 110.

A timer display connection menu button 1755 is provided and is configured to receive input to open a menu presenting additional options regarding discovering, connection to, managing and operating available timer displays. A schedule menu button 1760 is also provided and is configured to receive input to display a menu of different exercise schedule types/templates and other options relating to functionality of timer application. A timer display connection status 1765 is also provided and is configured to display whether the timer application is connected to any timer display, and if so, the identification of the connected timer display. In screenshot 1700, timer display connection status 1765 indicates that the timer application is not connected to any active timer displays. Moreover, timer application can be configured to expand application timer 1705 to full-screen when the mobile device is rotated from portrait to landscape orientation.

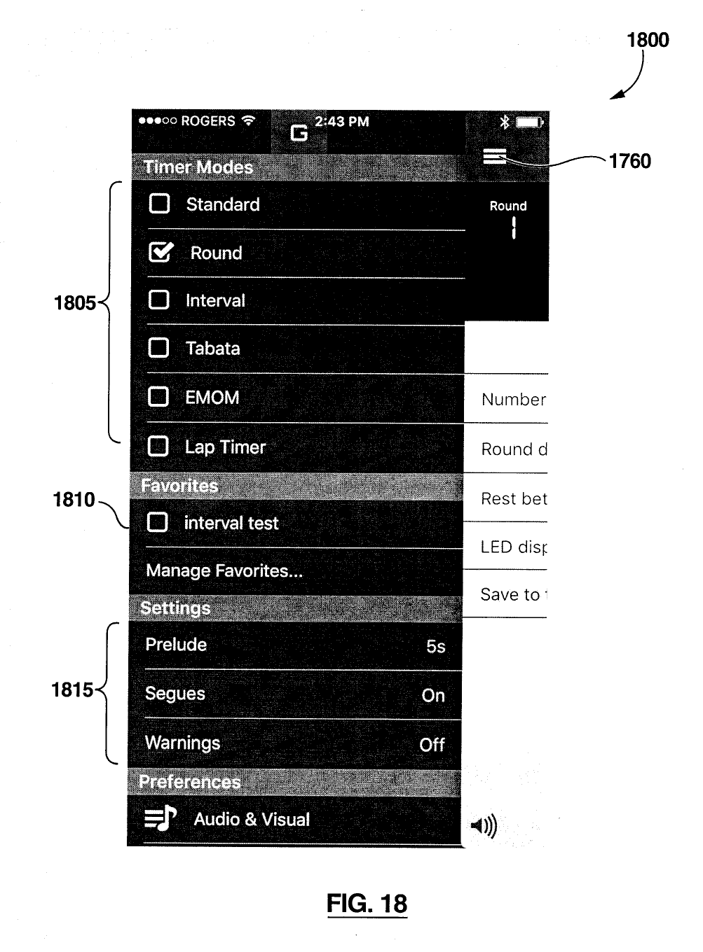

FIG. 18 shows screenshot 1800 showing a top portion of the menu displayed when schedule menu button 1760 is selected. The top portion of the menu displays schedule types including standard, round, interval, Tabata, EMOM (every minute on the minute), and lap timer schedule templates. The menu also provides a list of saved favorite schedules 1810. In addition, the menu provides configurable prelude, segue, and warning options 1815. The prelude specifies a countdown before a schedule starts. The segue provides a short countdown when transitioning between different components of a given schedule; for example, between exercise and rest periods in a given schedule. The warning can be configured to specify a notification at a given time before the end of a schedule or a component of a schedule. In addition, the warning options allow for the type of audible warning emitted by the timer display 105 to be selected.

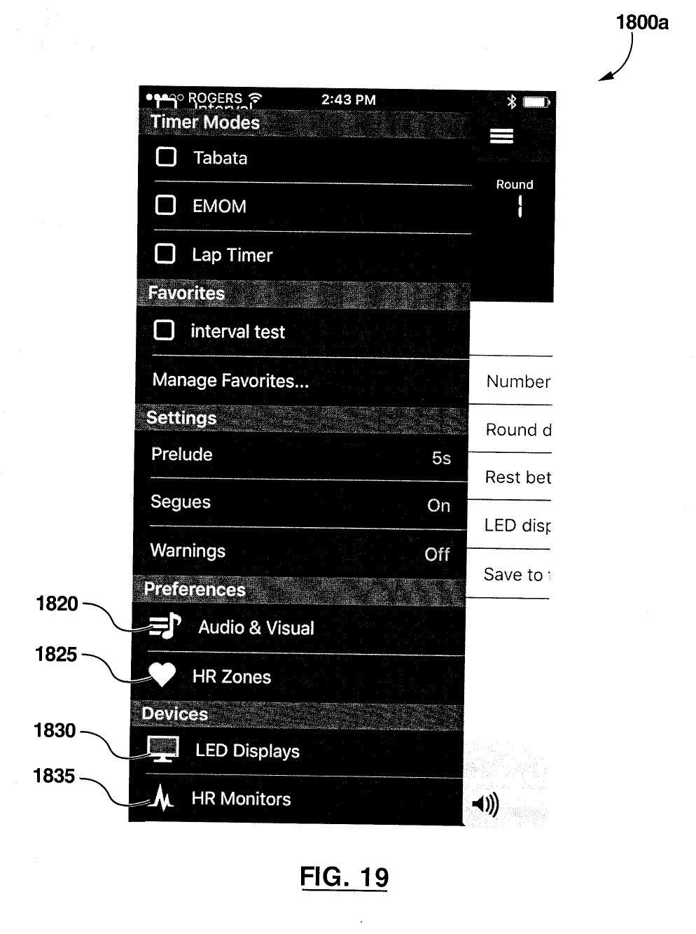

FIG. 19 depicts screenshot 1800a showing a bottom portion of the menu displayed when schedule menu button 1760 is selected. There is some overlap between the top portion of the menu depicted in screen shot 1800 and the bottom portion of the same menu depicted in screenshot 1800a. Additional menu items visible in screenshot 1800a comprise audio & visual settings 1820, heart-rate zone settings 1825, connected timer displays settings 1830, and heart-rate monitor settings 1835.

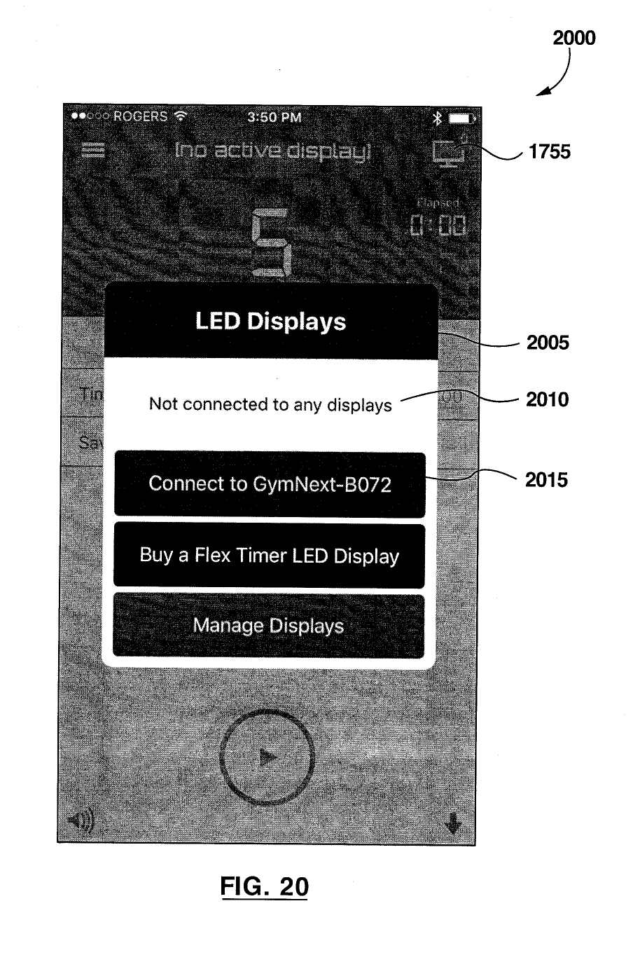

FIG. 20 shows a screenshot 2000, depicting a timer display connection pop-up 2005 displayed when timer display connection menu 1755 is selected and no timer display is connected to mobile device 110. Pop-up 2005 presents several options including a timer display connection status 2010 and a timer display connection option 2015. A selection of timer display connection option 2015 would prompt the timer application, and mobile device 110 on which it is running, to connect to timer display 105.

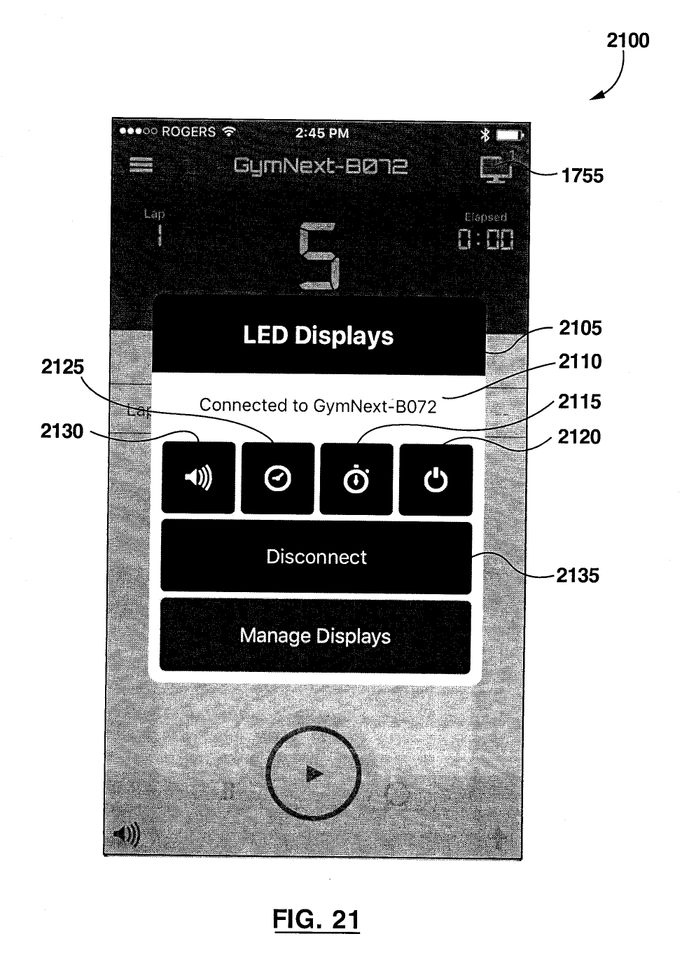

FIG. 21 shows a screenshot 2100, depicting a connected timer display pop-up 2105 displayed when timer display connection menu 1755 is selected and timer display 105 is connected to mobile device 110. Connected timer display pop-up 2105 provides a timer display connection status 2110 displaying the identification name/number of connected timer display 105. In addition, pop-up 2105 provides a timer mode selection button 2115 to switch timer display 105 to timer mode, a timer display on/off button 2120 to turn timer display 105 on and off, a clock mode selection button 2125 to switch timer display 105 to clock mode, and a mute button 2130 to mute audible notifications emitted by timer display 105. Other clock display options and settings (not depicted) can include controlling the time zone associated with the chronological time display, and controlling a 12 h vs. 24 h display associated with the chronological time display. Moreover, pop-up 2105 also provides a timer display disconnect button 2135 to disconnect timer display 105 from mobile device 110 running the timer application.

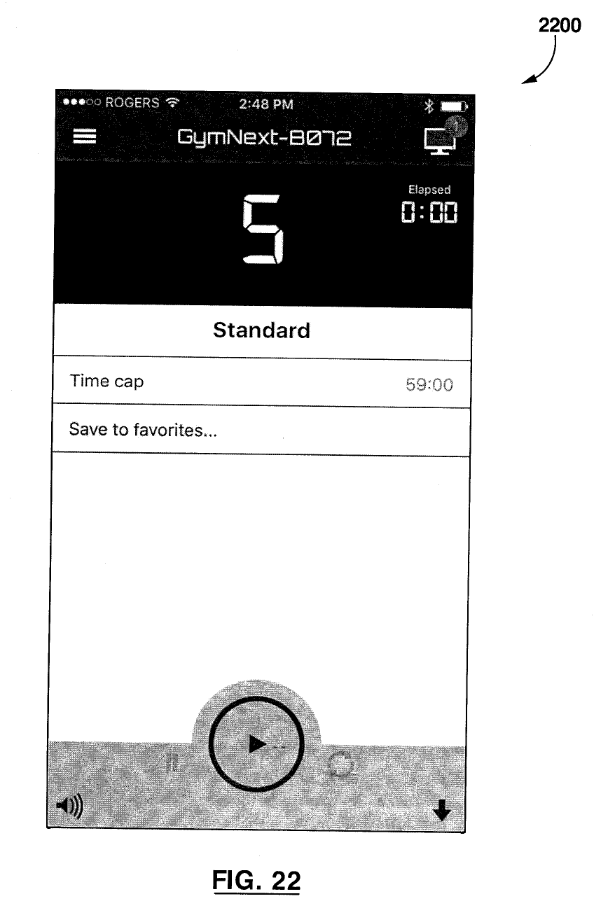

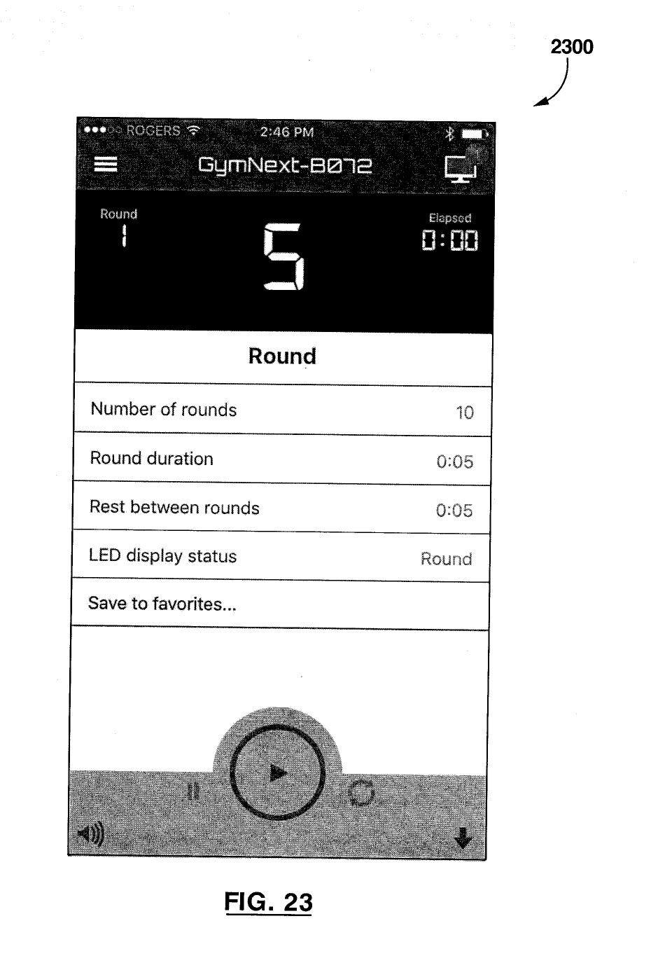

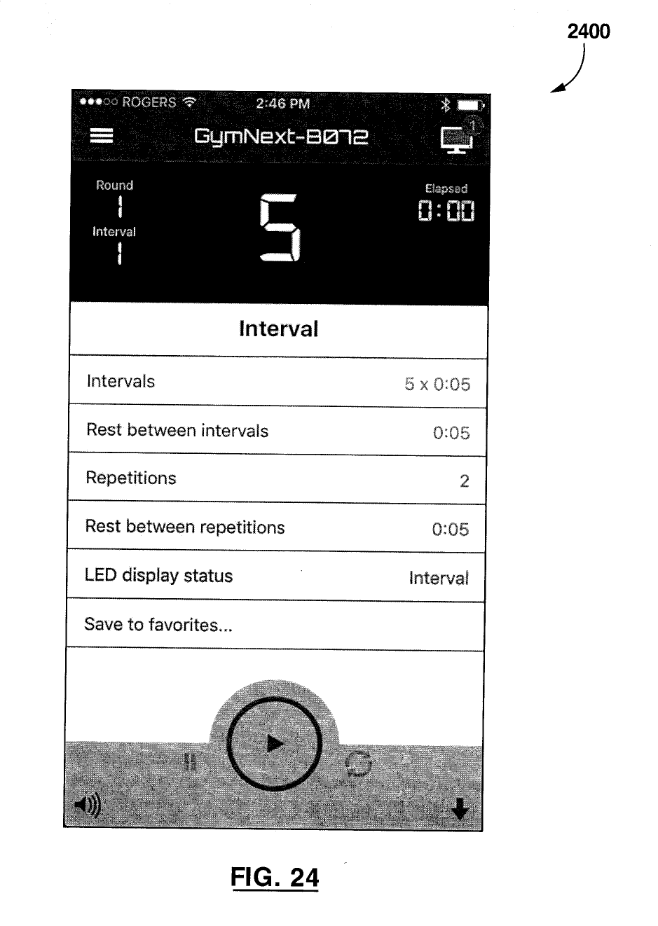

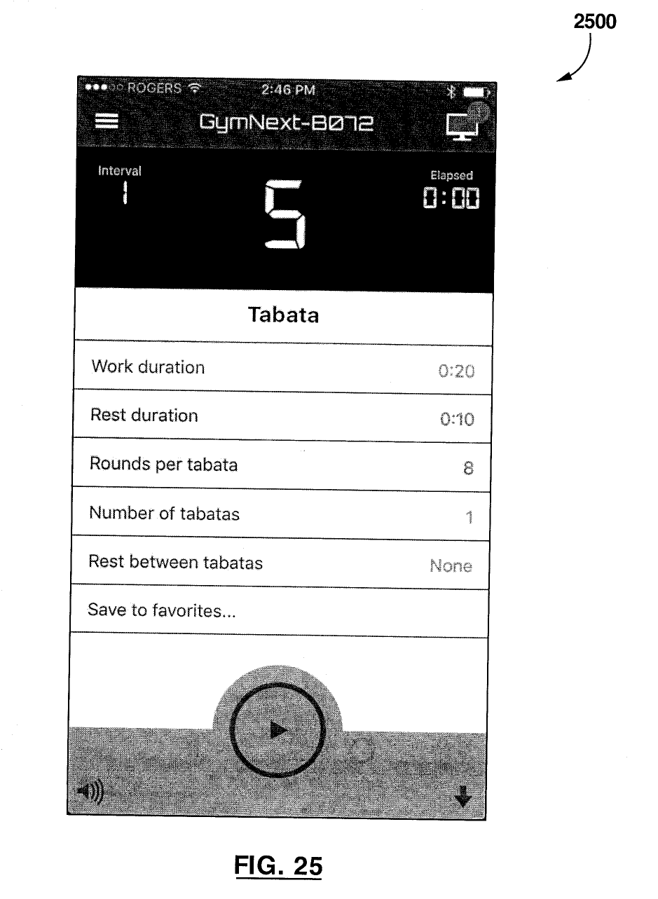

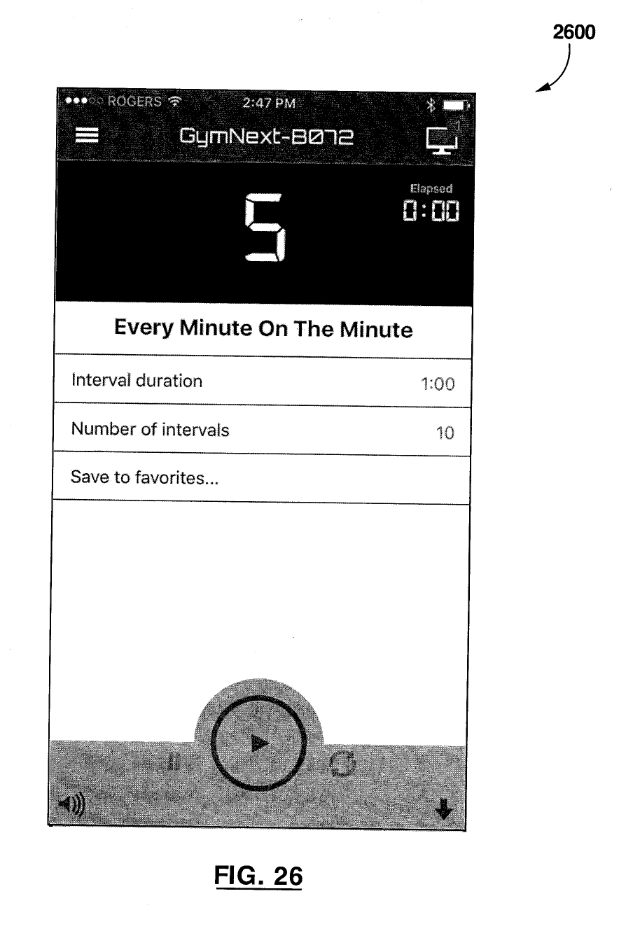

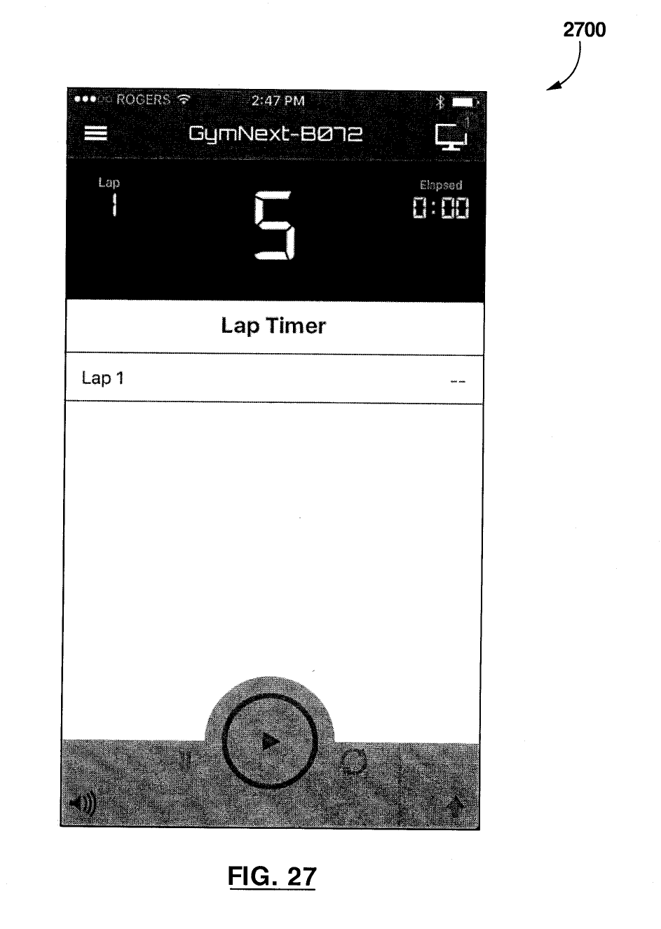

FIG. 22 shows a screenshot 2200 depicting information presented by the application timer when the “standard” schedule type is selected. FIG. 23 shows a screenshot 2300 depicting information presented by the application timer when the “round” schedule type is selected. FIG. 24 shows a screenshot 2400 depicting information presented by the application timer when the “interval” schedule type is selected. FIG. 25 shows a screenshot 2500 depicting information presented by the application timer when the “Tabata” schedule type is selected. FIG. 26 shows a screenshot 2600 depicting information presented by the application timer when the “Every Minute On The Minute” schedule type is selected. FIG. 27 shows a screenshot 2700 depicting information presented by the application timer when the “Lap Timer” schedule type is selected. In FIGS. 22-27, some of all of the schedule parameters for each schedule type can be editable.

The operation of timer display 105 and its control by mobile device 110 will now be described. As shown in the various screenshots depicted in the Figures and described above, a selection of a schedule can be received through the graphical user interface (GUI) presented by the timer application running on mobile device 110. For example, schedule type “Round” can be selected after activating menu button 1760, shown in screenshot 1800 depicted in FIG. 18. In addition to schedule type, schedule details 1715 can also be editable; an example of schedule details 1715 is shown in screenshot 1700 depicted in FIG. 17. Before and/or after selecting the schedule, through the GUI a connection input can be received to connect mobile device 110 to a timer display such as timer display 105. For example, the connection input can be in the form of selection/activation of the timer display connection option 2015 shown in screenshot 2000 depicted in FIG. 20.

In response to the connection input, the mobile device attempts to connect directly to timer display 105. Referring back to FIG. 2, timer display 105 can be configured to connect directly to mobile device 110 running the timer application. The connection is via communication interface 220 and using two-way data communication protocol 130 (depicted in FIG. 1). Two-way data communication protocol 130 can comprise Bluetooth™, which can in turn comprise Bluetooth™ Classic and/or Bluetooth™ LE.

Bluetooth™ provides a low latency, non-line-of-sight communication protocol, which allows for near real-time direct communication between timer display 105 and mobile device 110. Moreover, Bluetooth™ can have a longer range than older communication means such as IR controllers. In addition, Bluetooth™ allows for data communication to be encoded and/or formatted as data packets, which packet can contain 20 bytes of information. This can allow for multiple short commands to be formatted and included in one data packet. In some implementations, each command can be formatted as a two-byte code followed by some parameters, which can in turn allow multiple commands to be communicated in fewer than 20 bytes thereby fitting in a single packet. When multiple commands are packaged into a single packet, the multiple commands can be delimited with a semicolon. Moreover, the data packet format allows repetitive messages to be sent in abbreviated form; for example, a schedule that specifies ten rounds of sixty seconds each, can be communicated as “10×60” instead of communicating “sixty seconds” ten times. In contrast to Bluetooth™, older communication means such as IR controllers can only send very simple commands, one at a time, and cannot receive any confirmations or status updates from the device they are attempting to control.

In addition, Bluetooth™ has a relatively low rate of dropped packets, which can allow for the communication scheme between timer display 105 and mobile device 110 to operate without using automatic message delivery retry mechanisms, such as those present in Wi-Fi (TCP/IP) communication schemes. Without automatic delivery retry, any dropped packets would be manually resent if necessary. However, as Bluetooth™ has relatively few dropped packets, the need for manual resends can be minimal. The elimination of automatic delivery retries can contribute to making Bluetooth™ faster and more power-efficient than Wi-Fi.

The characteristics of the two-way data communication protocol implemented using Bluetooth™ described above can increase communication efficiency by reducing the amount of time and power (e.g. battery power) necessary to communicate between timer display 105 and mobile device 110.

While communication using Bluetooth™ as the two-way data communication protocol is described above, it is contemplated that generally two-way data communication protocol 130 can comprises any wireless communication protocol configured for near real-time, non-line-of-sight communication between timer display 105 and mobile device 110, such that the communication has a latency less than about 3 s. In other implementations, the latency can be less than or equal to about 1 s. In yet other implementations, the latency can be less than or equal to about 0.1 s. Two-way data communication protocol 130 can comprise any suitable protocol, including but not limited to protocols usable to set up a wireless personal area network (WPAN) such as INSTEON, ZigBee, IrDA, Wireless USB, and Z-Wave.

To make the connection between timer display 105 and mobile device 110 using Bluetooth™, a command from internal Bluetooth™ libraries can be run, exemplified generically as BluetoothManager.connect(timer display). After the connection is made, timer display 105 can be configured to receive the schedule from mobile device 110 via communication interface 220, which selection of the schedule was received through the GUI associated with the timer application, as described above. The schedule can be received in the form of one or more data packets formatted according to the Bluetooth™ protocol.

Once received, timer display 105 can store the schedule in memory 225. Storing the schedule in memory can enable timer display 105 to continue running the schedule if timer display 105 becomes disconnected from mobile device 110. In addition storing the schedule in memory reduces the need for multiple and/or frequent transmissions of schedule data from mobile device 110 to timer display 105.

Timer display 105 is also configured to transmit via communication interface 220 to mobile device 110 a confirmation of connection and a status of timer display 105. The status is described in greater detail below. The confirmation and the status are transmitted in the form of one or more data packets formatted according to the Bluetooth™ protocol. Timer display 105 is also configured to receive via communication interface 220 one or more control commands from mobile device 110. The control commands are also in the form of one or more data packets formatted according to the Bluetooth™ protocol. Once it receives the control commands, timer display 105 is configured to control via processor 205 one or more of the multi-segment LED digits 210 and sound generator 215 according to the control commands.

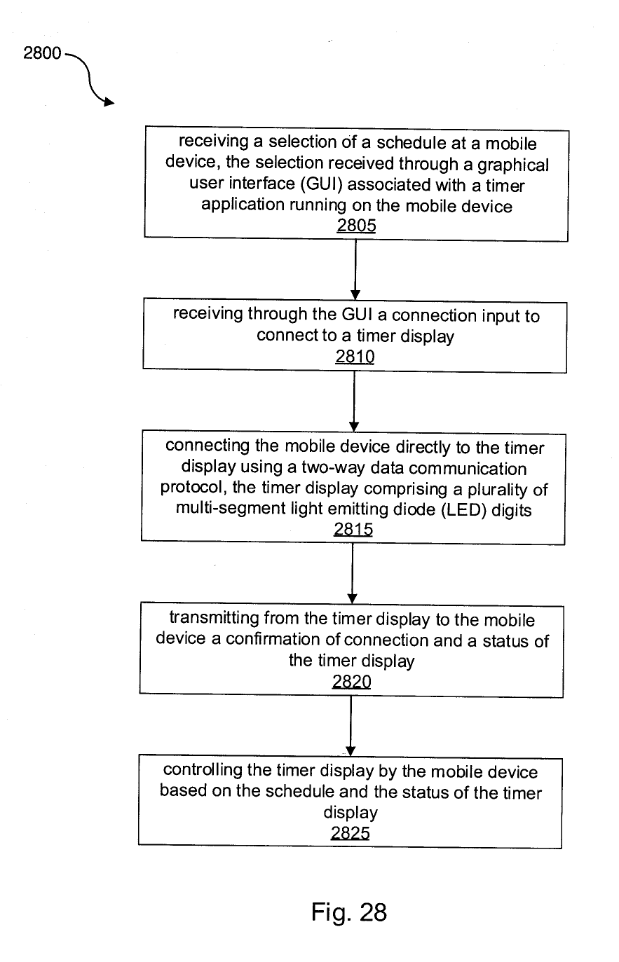

Now, methods of communication between timer display 105 and mobile device 110 running timer application will be described, which methods are used to control timer display 105 using mobile device 110. FIG. 28 shows a flowchart depicting steps in method 2800 for communication between timer display 105 and mobile device 110. At step 2805 a selection of the schedule is received at mobile device 110. At step 2810, the connection input to connect to timer display 105 is received. As described above, the selection and the connection input can be received through a GUI associated with the timer application running on mobile device 110.

At step 2815, mobile device 110 is connected directly to timer display 105 using two-way data communication protocol 130 (shown in FIG. 1). Timer display 105 can comprise a plurality of multi-segment LED digits 210 (shown in FIG. 2). As described above, in some implementations timer display 105 can comprise suitable emissive and/or reflective displays other than multi-segment LED digits. As described above, two-way data communication protocol 130 can comprise the Bluetooth™ protocol. In other implementations, two-way data communication protocol 130 can comprise generally a wireless communication protocol configured for near real-time, non-line-of-sight communication between timer display 105 and mobile device 110, such that the communication has a latency less than about 3 s. In other implementations, the latency can be less than or equal to about 1 s. In yet other implementations, the latency can be less than or equal to about 0.1 s.

At step 2820, timer display 105 can transmit to mobile device 105 a confirmation of connection and a status of timer display 105. In some implementations, the status can comprise one of an unavailability indication and an availability indication. The unavailability indication can be associated with timer display 105 actively counting time or timer display 105 being paused while displaying non-default start values. Default start values can be the values displayed by timer display 105 when it is currently in a state other than the state of being initialized and/or loaded with a given schedule. For example, default start values can comprise, but are not limited to, zeros at some or all LED digits, dashes at some or all LED digits, blanks at some or all LED digits, and/or the chronological clock being displayed at some or all LED digits.

The availability indication can be associated with timer display 105 being in a state other than actively counting time and displaying non-default start values. In other words, the availability indication can be associated with timer display 105 being in a state other than the state of being currently initialized and/or loaded with and/or running a given schedule. In some implementations, when the status comprises the unavailability indication, the status also comprises a timer display schedule identifier. This identifier can identify the schedule being loaded onto and/or run by timer display 105, and whether and when incrementing/decrementing that schedule was started. In some implementations, the identifier can comprise a random integer generated at mobile device 110 and communicated to timer display 105 when a start input is transmitted to timer display 105. A copy of this identifier can be kept on mobile device 110, and later comparison between the identifiers on timer display 105 and mobile device 110 can allow for determining whether timer display 105 and mobile device 110 are running the same schedule in synch with one another.

At step 2825, timer display 105 can be controlled by mobile device 110 based on the schedule and the status of timer display 105. The controlling is described in greater detail below. After the initial connection is made between timer display 105 and mobile device 110, subsequent communications between timer display 105 and mobile device 110 can be in the form of one or more data packets formatted according to two-way data communication protocol 130, as described above.

In some implementations, method 2800 can comprise additional steps between steps 2815 and 2820. These additional steps can comprise mobile device 110 transmitting to timer display 105 1) a seed for the current chronological clock, and 2) an audio state and an increment-decrement clock direction associated with the timer application. Timer display 105 can store in memory 225 (shown in FIG. 2) the seed, the audio state, and the increment-decrement clock direction. The seed can comprise a coordinated universal time (UTC) clock seed accompanied by a time zone, and optionally a daylight savings time state and a 12- or 24-hour time display preference. The audio state can comprise audio presets and/or preferences including, but not limited to, style and format of audio notifications. The audio state can also comprise presets and/or selections for buzzer on/off and segue on/off settings. The increment-decrement clock direction can comprise a selection of whether timer display 105 should count up (increment) or count down (decrement) any time periods specified in the schedule.

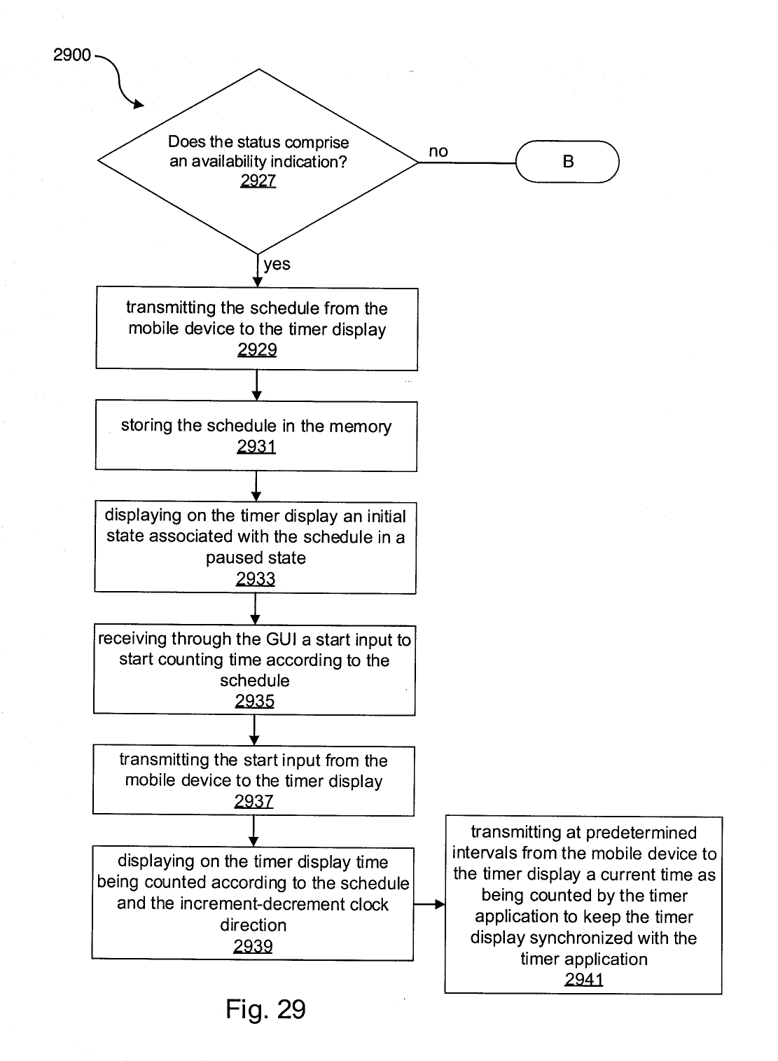

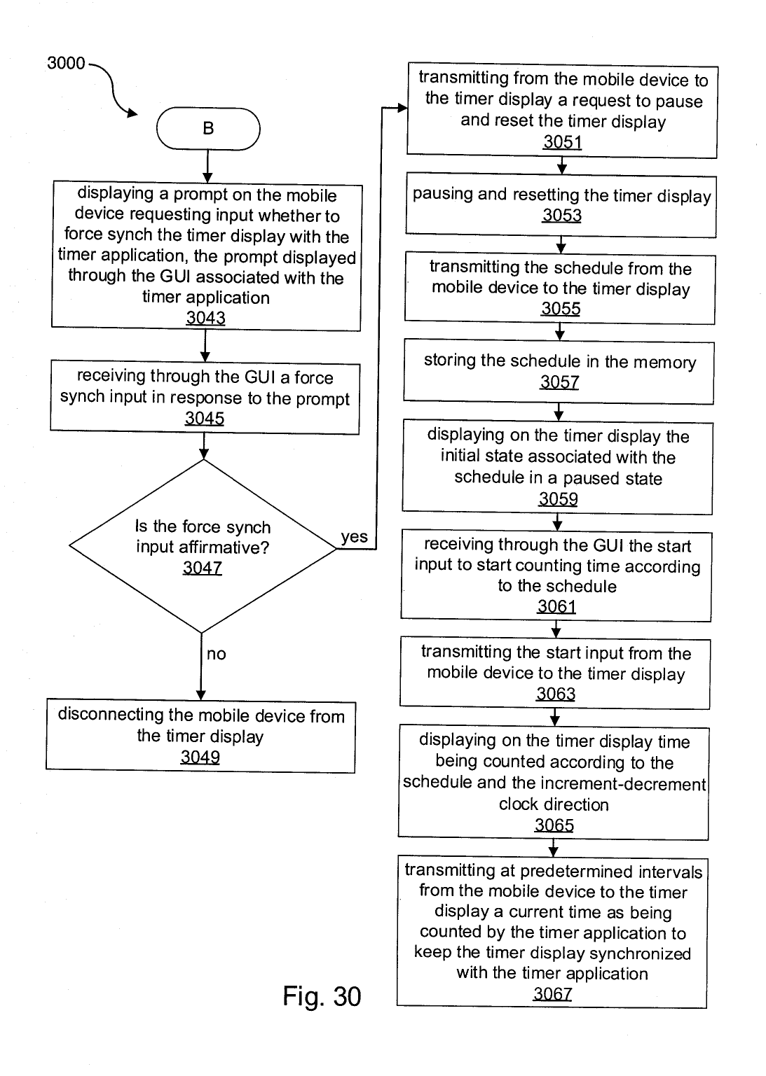

In some implementations, the controlling at step 2825 can comprise the combination of methods 2900 and 3000 depicted in FIGS. 29 and 30 respectively. Referring now to FIG. 29, at step 2927 a determination is made as to whether the status comprises the availability indication. If the determination is affirmative, then at step 2929 the schedule is transmitted from mobile device 110 to timer display 105, followed by step 2931 where the schedule is stored in memory 225. At step 2933, an initial state associated with the schedule is displayed in a paused state on timer display 105. For example, if the selected schedule is of the “standard” type with a time cap of 59 minutes (see FIG. 22), then timer display 105 can display the initial state of zero in preparation for counting up to 59 minutes, or display the initial state of 59:00 in preparation for counting down to zero. Which initial state is displayed can be determined by the increment-decrement setting communicated from mobile device 110 to timer display 105.

Referring briefly to FIG. 22, in screenshot 2200 the application timer is showing “5” as the initial state. In this case, a five second segue was selected in the options, whereby a five-second countdown is provided before the timer starts incrementing/decrementing the 59:00 schedule.

Returning to FIG. 29, at step 2935 the start input can be received through the GUI to start counting time according to the schedule. An example of the start input can comprise activation of start button 1730, as shown in FIG. 17. At step 2937, the start input is transmitted from mobile device 110 to timer display 105. At step 2939, time being counted is displayed on timer display 105, with the time being counted according to the schedule and the increment-decrement clock direction.

In some implementations, while counting time according to the schedule, timer display 105 can also emit one or more sounds according to the schedule and the audio state. These sounds can include, but are not limited to, start and finish buzzers, start and finish warnings, and segue beeps and/or audible count-downs. In implementations where timer display 105 does not comprise a sound generator capable of reproducing human-intelligible speech (e.g. a speaker), the count-down can be generated by a speaker of mobile device 110 or by an external speaker (e.g. a Bluetooth™ speaker) in communication with mobile device 110. In some implementations, a Bluetooth™ speaker can be incorporated into timer display 105.

In some implementations, at step 2941 a current time as being counted by the timer application can be transmitted at predetermined intervals from mobile device 110 to timer display 105. These periodic transmissions can be used to keep timer display 105 synchronized with the timer application running on mobile device 110. In some implementations, these predetermined intervals comprise about 60 s.

On the other hand, if the determination at step 2927 is negative (i.e. the status comprises instead the unavailability indication), then the next step is step 3043 of method 3000 depicted in FIG. 30. At step 3043, a prompt is displayed on mobile device 110 requesting input whether to force synch timer display 105 with the timer application. The prompt is displayed through the GUI associated with the timer application. Next, at step 3045, a force synch input can be received through the GUI in response to the prompt. At step 3047, it is determined whether the force synch input is affirmative. If the force synch input is not affirmative (i.e. is negative), then method 3000 proceeds to step 3049 where mobile device 110 is disconnected from timer display 105. This represents an exemplary situation where timer display 105 is already running another schedule, and because the force synch input is negative, no further steps are taken to force synch timer display 105 with the timer application running on mobile device 110.

In some implementations, instead of disconnecting at step 3049, mobile device 110 can remain connected to timer display 105, but refrain from sending the schedule to timer display 105, pausing or resetting timer display 105, and/or otherwise force synching timer display 105 with mobile device 110.

If, on the other hand, the determination at step 3047 is positive, then at step 3051 a request to pause and reset timer display 105 is transmitted from mobile device 110 to timer display 105. At step 3053, timer display 105 is paused and reset. Then, at step 3055, the schedule is transmitted from mobile device 110 to timer display 105. At step 3057, the schedule is saved in memory 225 (see FIG. 2) of timer display 105.

At step 3059, the initial state associated with the schedule is displayed in a paused state on timer display 105. This step can be similar to step 2933 shown in FIG. 29. At step 3061 the start input can be received through the GUI to start counting time according to the schedule. At step 3063, the start input is transmitted from mobile device 110 to timer display 105. At step 3065, time being counted is displayed on timer display 105, with the time being counted according to the schedule and the increment-decrement clock direction.

In some implementations, at step 3067 a current time as being counted by the timer application can be transmitted at predetermined intervals from mobile device 110 to timer display 105. Generally, steps 3059, 3061, 3063, 3065, and 3067 can be similar to steps 2933, 2935, 2937, 2939, and 2941 respectively. Steps 3051 to 3067 represent an exemplary situation where timer display 105 is already running another schedule, and because the force synch input is affirmative, steps are taken to force synch timer display 105 with the timer application on mobile device 110.

It is also contemplated that in methods 2800, 2900, and 3000, and generally in all the methods described herein, there can be confirmation steps after each command or informational message is communicated between timer display 105 and mobile device 110. Generally only one confirmation is sent after any command or informational message, and the methods do not require sending confirmations of confirmations.

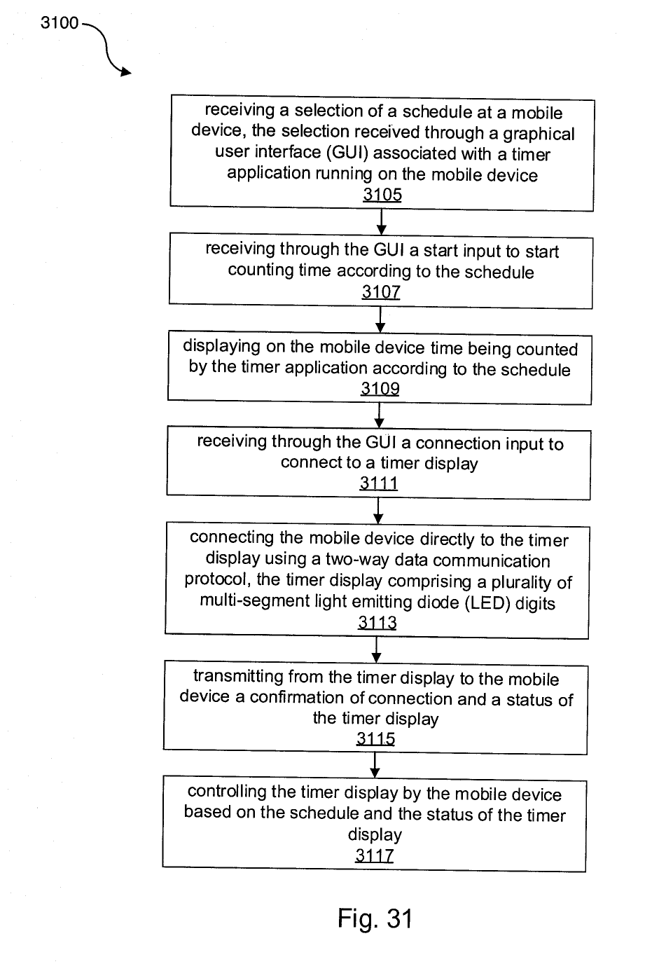

Turning now to FIG. 31, another method 3100 is depicted for communication between timer display 105 and mobile device 110. Step 3105 is generally similar to step 2805 of method 2800, and will not be described in detail here. At step 3107, a start input to start counting time according to the schedule is received through the GUI. As a result, the application timer starts counting time and at step 3109, time being counted by the timer application according to the schedule is displayed on mobile device 110. As such, method 3100 represents a situation where the application timer is already running and counting time according to a schedule before input is received to connect mobile device 110 to timer display 105.

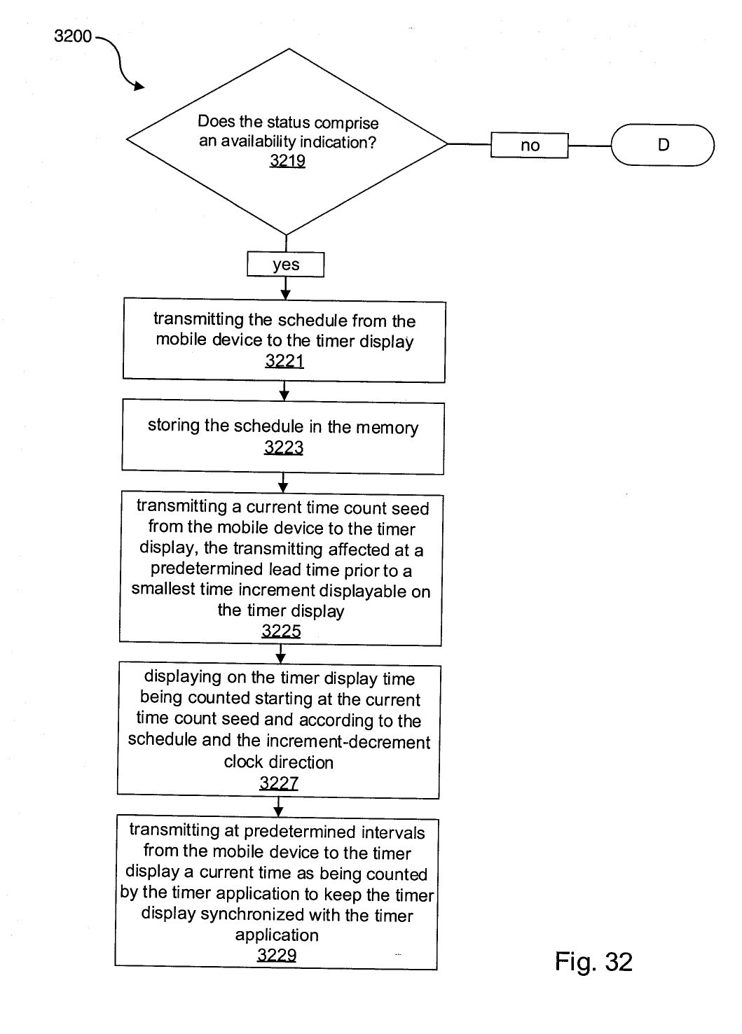

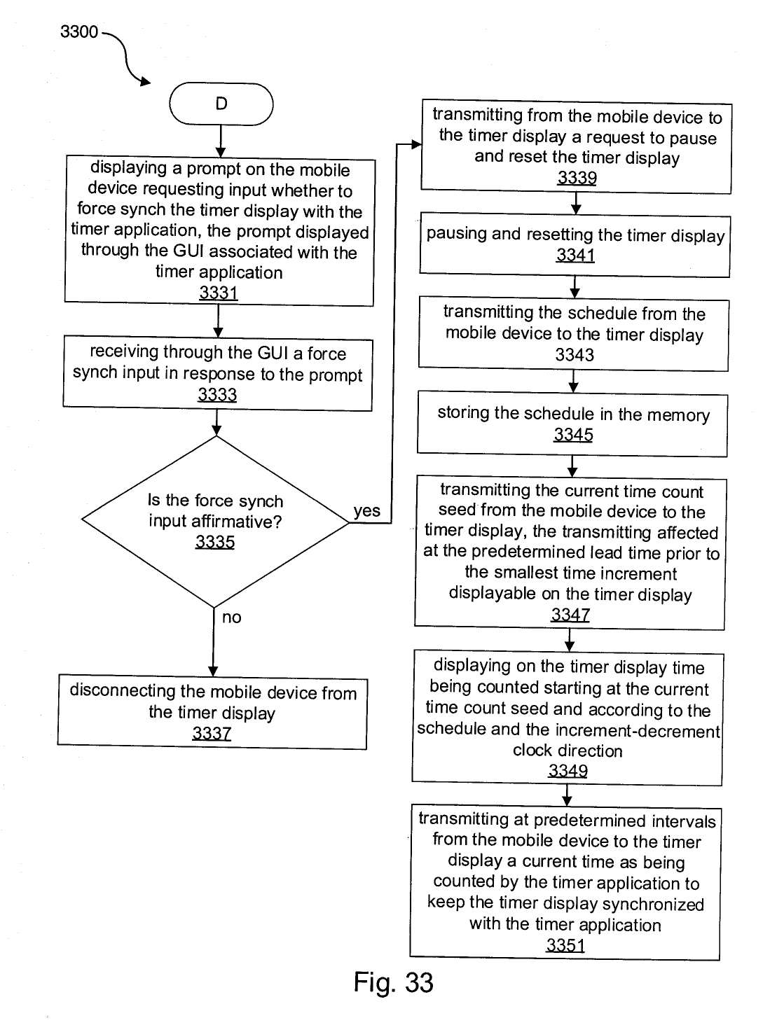

Steps 3111, 3113, 3115, and 3117 are generally similar to steps 2810, 2815, 2820, and 2825 respectively of method 2800, and will not be described in detail here. Methods 3200 and 3300, depicted in FIGS. 32 and 33 respectively, provide details of the controlling in step 3117 of method 3100. Turning now to FIG. 32, at step 3219 a determination is made as to whether the status comprises an availability indication. If the determination is affirmative, method 3200 proceeds to step 3221 where the schedule is transmitted from mobile device 110 to timer display 105 and is stored in memory 225 in step 3223.

Next, at step 3225, the current time count seed is transmitted from mobile device 110 to timer display 105. The current time count seed is the current time count that the application timer is displaying at any given point in time as the application timer increments/decrements through the schedule. The transmitting is affected at a predetermined lead time prior to a smallest time increment displayable on timer display 105. In some implementations, the smallest time increment displayable on timer display 105 can be 1 s, and the predetermined lead time can be 10 ms. In such an implementation, the timer application can wait until 10 ms before the next second is about to be incremented/decremented in the application timer and can then send the current time count seed to timer display 105. The lead time can provide a window of time for timer display 105 to receive the current time count seed and synchronize its state and its LED digits in preparation for counting the time according to the schedule and in synchrony, or near synchrony, with the application timer.

Next, at step 3227, timer display 105 displays time being counted starting at the current time count seed and according to the schedule and the increment-decrement clock direction. In some implementations step 3229 follows, which step is generally similar to step 2841 (see FIG. 28) and will not be discussed in detail here.

If, on the other hand, the determination at step 3219 is negative (i.e. if the status comprises an unavailability indication), then the next step is step 3331 of method 3300 shown in FIG. 33. Steps 3331, 3333, 3335, 3337, 3339, 3341, 3343, and 3345 are generally similar to steps 3043, 3045, 3047, 3049, 3051, 3053, 3055, and 3057 respectively of method 3000, and will not be described in detail here. Turning next to steps 3347, 3349, and 3351, these steps are generally similar to steps 3225, 3227, and 3229 of method 3200, and will not be described in detail here. Methods 3100, 3200, and 3300 together address the situation where the application timer is already counting time according to the schedule when the connection input is received to connect mobile device 110 to timer display 105.

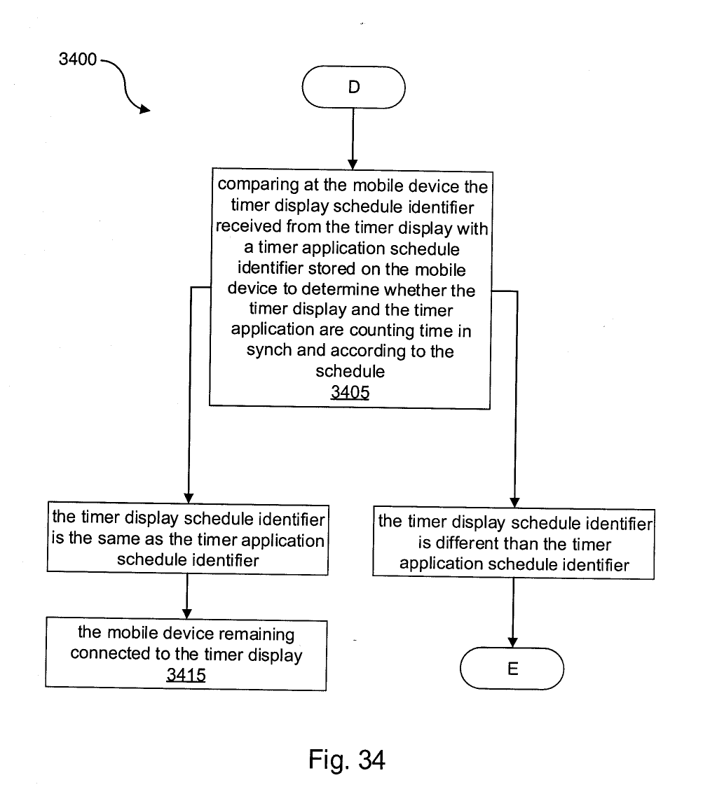

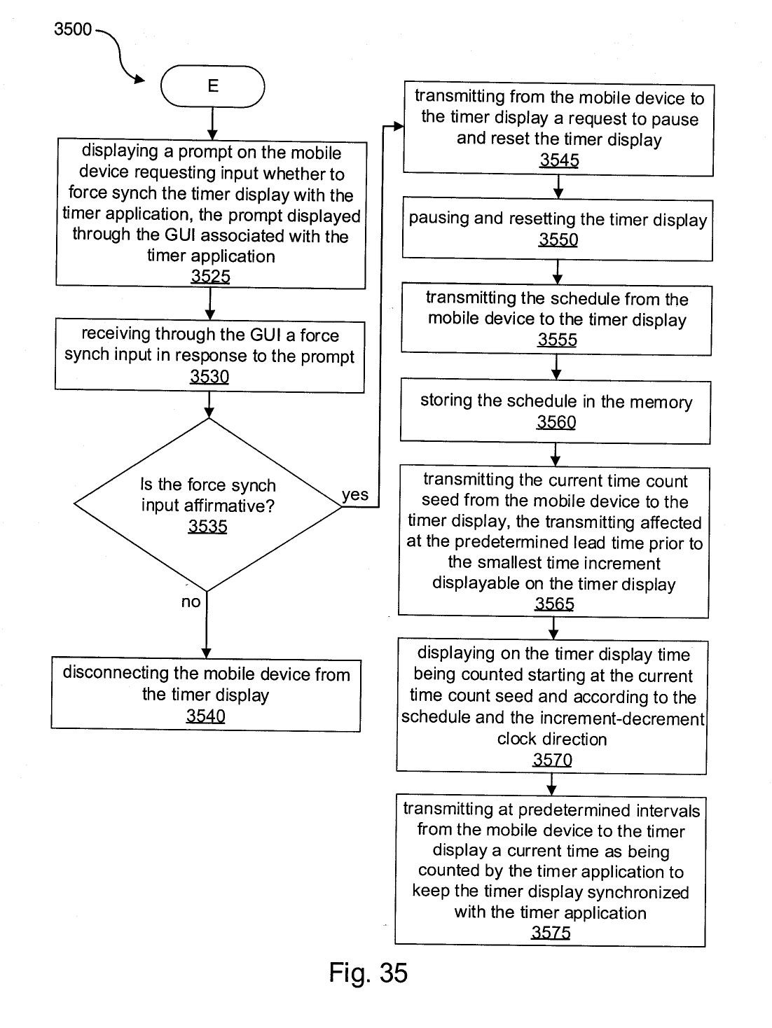

FIGS. 34 and 35 respectively depict methods 34 and 35 which together represent another method of communication between timer display 105 and mobile device 110, which method has some steps in common with methods 3100, 3200, and 3300. Method 3400 starts from the negative determination at step 3219 of method 3200. Next, at step 3405, at mobile device 110 the timer display schedule identifier received from timer display 105 is compared with a timer application schedule identifier stored on mobile device 110. The timer application schedule identifier is similar to and the counterpart of the timer display schedule identifier, with the difference being that the timer application schedule identifier is stored on mobile device 110 whereas the timer display schedule identifier is stored in memory 225 onboard timer display 105. The comparison is performed to determine whether timer display 105 and the timer application are counting time in synch and according to the same schedule.

If the timer display schedule identifier is the same as the timer application schedule identifier, then method 3400 moves to step 3415 where mobile device 110 remains connected to timer display 105. If, however, the timer display schedule identifier is different than the timer application schedule identifier, then the next step is step 3525 of method 3500. Steps 3525, 3530, 3535, 3540, 3545, 3550, 3555, 3560, 3565, 3570, and 3575 of method 3500 are generally similar to steps 3331, 3333, 3335, 3337, 3339, 3341, 3343, 3345, 3347, 3349, and 3351 respectively of method 3300, and will not be described in detail here. Methods 34 and 35 address a situation where the application timer is already counting time according to the schedule when the connection input is received to connect mobile device 110 to timer display 105. In this situation, before displaying the prompt requesting input whether to force synch, a determination is made as to whether the application timer and timer display 105 are running the same schedule and in synchrony. If the determination is affirmative, then there is no need for a force synch as the application timer and timer display 105 are already synchronized.

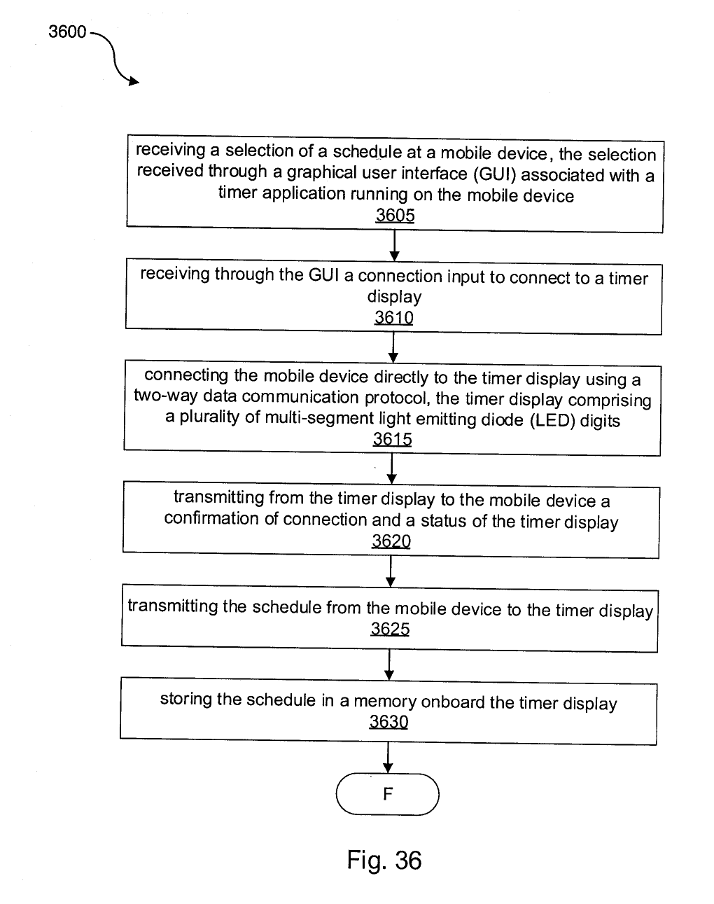

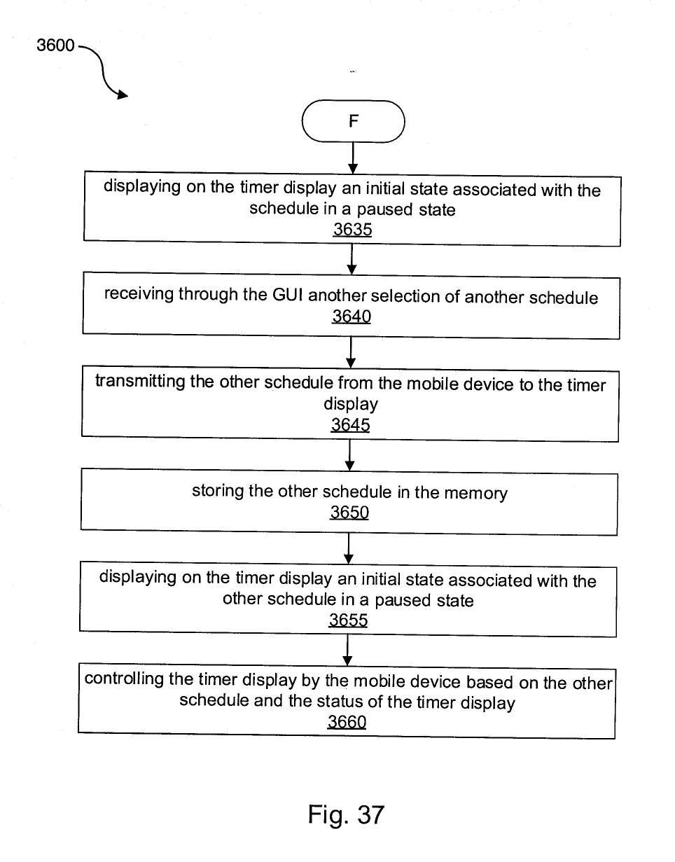

Turning next to FIGS. 36 and 37, steps of a method 3600 are depicted. Referring to FIG. 36, steps 3605, 3610, 3615, and 3620 are generally similar to steps 2805, 2810, 2815, and 2820 respectively of method 2800, and will not be described in detail here. After step 3620, method 3600 moves to step 3625 where the schedule is transmitted from mobile device 110 to timer display 105. Next, at step 3630, the schedule is stored in memory 225 onboard timer display 105.

Next, method 3600 moves to step 3635 shown in FIG. 37. At step 3635 an initial state associated with the schedule is displayed in a paused state on timer display 105. Step 3635 is generally similar to step 3059 of method 3000, and will not be described in detail here. Next, at step 3640 another selection of another schedule is received through the GUI, and at step 3645 the other schedule is transmitted from mobile device 110 to timer display 105. The other schedule is stored in memory 225 at step 3650.

At step 3655, an initial state associated with the other schedule is displayed in a paused state on timer display 105. Step 3655 is generally similar to step 3059 of method 3000, and will not be described in detail here. Next, at step 3660, timer display 105 is controlled by mobile device 110 based on the other schedule and the status of timer display 105. Step 3660 is generally similar to step 2825 of method 2800, with the main difference being that in step 3660 the controlling is based on the other schedule received after initially receiving the schedule, whereas in step 2825 no second, other schedule is received and the controlling is based on the initially-received schedule.

Method 3600 addresses the situation where the menu of schedule types (e.g. as shown in FIG. 18) is used to browse between different schedule types. When a first schedule is selected, timer display 105 displays in the paused state the initial state associated with that first schedule. When in the course of browsing, a new second schedule is selected, timer display 105 displays in the paused state the initial state associated with the new, second schedule. In general, in this manner, timer display 105 can be updated during browsing whenever a new schedule type is selected, which updating can in turn allow timer display to display in the paused state the initial state associate with whichever schedule type is selected at any given time during the course of the browsing.

Referring now briefly to FIG. 1, in some implementations wearable devices and/or sensors 115 can communicate data such as sensor data to mobile device 110, which sensor data can then be sent to timer displays 105 for being displayed. An exemplary method (not depicted) of communication between timer display 105, mobile device 110, and wearables/sensors 115 comprises a modified version of method 2800 shown in FIG. 28. Before step 2825, the method further comprises receiving through the GUI an input to display the sensor data on timer display 105 for a given display duration at one or more predetermined display times. The controlling at step 2825 can comprise, at each predetermined display time 1) receiving the sensor data at mobile device 110, 2) transmitting the sensor data from mobile device 110 to timer display 105, 3) clearing one or more portions of timer display 105 needed to display the sensor data, and 4) displaying the sensor data on timer display 105 for the given display duration.

The one or more portions of timer display 105 can comprise one or more multi-segment LED digits of timer display 105. For example, when the sensor data comprises heart rate data, two or three LED digits can be cleared and used to display the heart rate data. Clearing the LED digits can comprise ceasing to use those digits for displaying the schedule information. The sensor data can comprise any information regarding the physiological state and physical activity of a person exercising and/or information regarding the equipment/environment used for the exercise. For example, sensor data can comprise one or more of heart rate, blood oxygenation levels, skin physical and chemical properties, accelerometer and GPS data, gyroscope data, repetitions data measured by exercise equipment, and other suitable types of data.

The given display duration can be configurable and/or selectable. For example, a selection can be made through the GUI of the timer application to display heart rate data for 5 seconds when timer display 105 is counting time according to the schedule. The predetermined display times can also be selectable and can determine when and/or how often the sensor data is displayed. For example, a selection can be made through the GUI of the timer application to display sensor data every 60 seconds and/or at specified times in relation to the chronological clock (e.g. on 5 min. after the hour, 10 mins. after the hour, etc.). At or about each predetermined display time, the current (as of that display time) sensor data is collected and sent to timer display 105 to be displayed for the given display duration.

When timer display 105 is counting time according to a schedule, timer display 105 can continue to count time in the background during the display duration(s) and/or continue to control and operate sound generator 215 (shown in FIG. 2) according to the schedule. It is also contemplated that timer display 105 can display sensor data even when timer display 105 is not otherwise running a schedule.

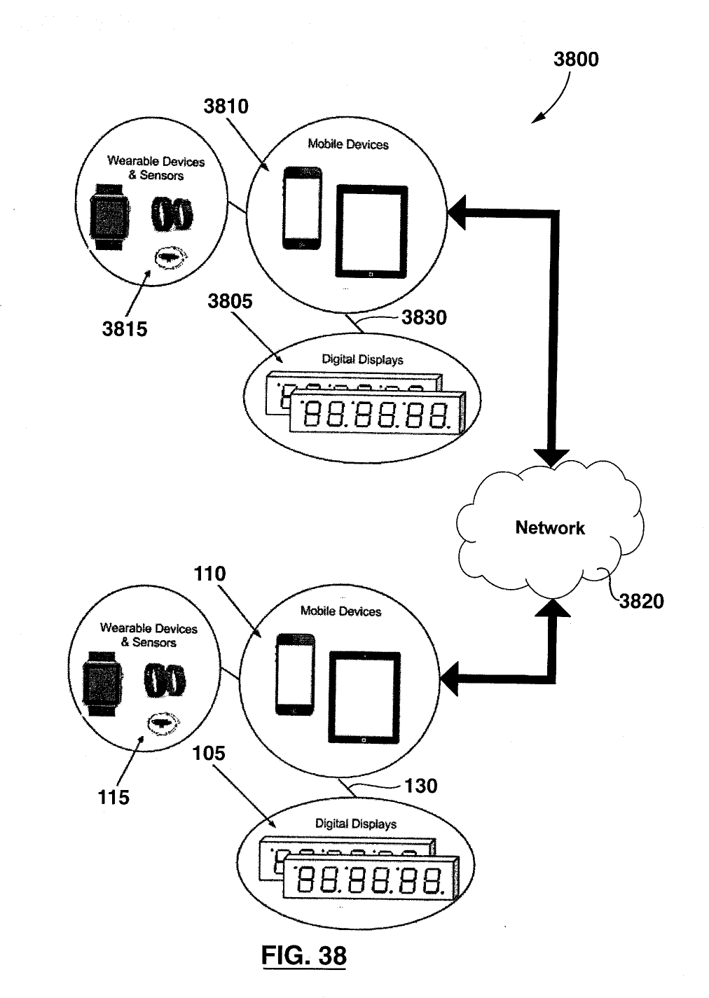

Turning now to FIG. 38, a schematic diagram of a system 3800 is shown. System 3800 comprises system 100 (as shown in FIG. 1) connected via mobile device 110 and network 3820 to mobile device 3810, which is in turn connected to timer display(s) 3805 over a two-way data communication protocol 3830. Mobile device 3810 is running a timer application similar to or the same as the timer application running on mobile device 110. Wearables and/or sensors 3815 can also be connected to mobile device 3810. Wearables and/or sensors 3815 can generally be similar to wearables and/or sensors 115. In other words, system 3800 can comprise two or more copies of system 100, with the respective mobile devices of each system connected to one another via a network. Network 3820 can comprise a wired or wireless network, including but not limited to the Internet, a cellular network, a wired phone network, and a satellite phone network.

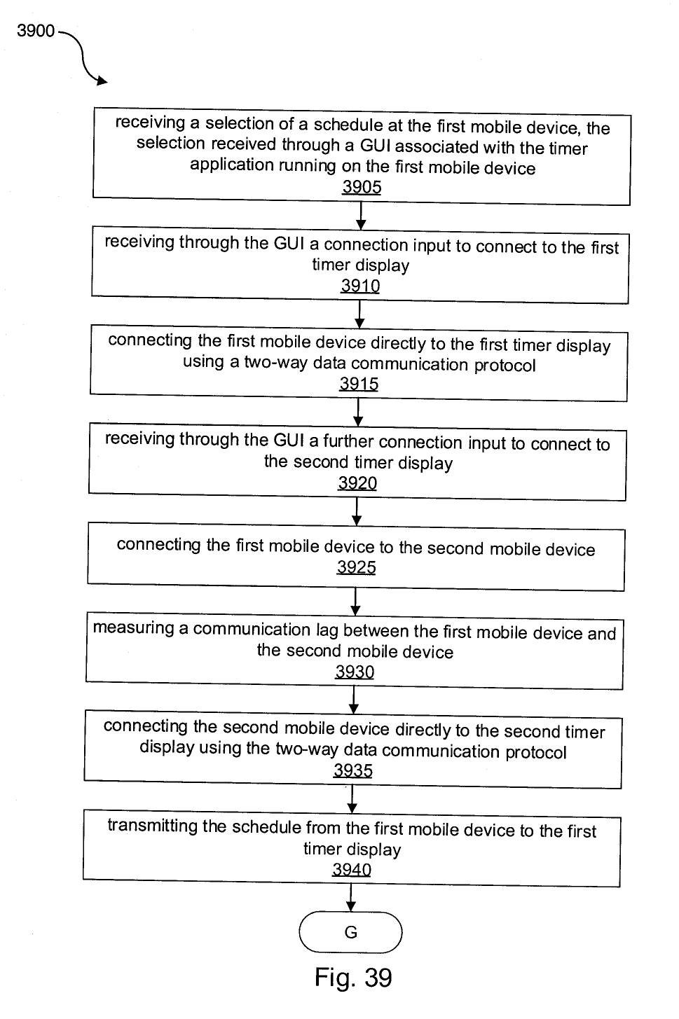

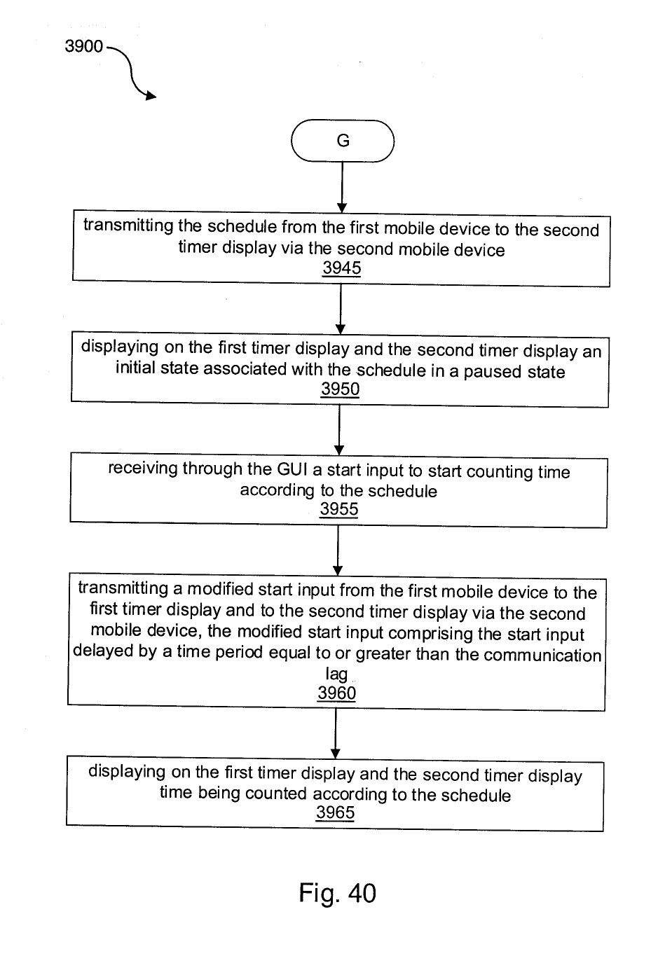

Using system 3800, one mobile device 110 can be used to control multiple sets of timer displays 105, 3805 which can be distant from each other. For example, the distance can comprise geographical separation in the sense of timer displays 105, 3805 being located in different cities, countries, or continents. FIGS. 39 and 40 depict an exemplary method 3900 for using mobile device 110 to control timer displays 105 and 3805. Referring to FIG. 39, at step 3905 a selection of a schedule is received at mobile device 110. The selection is received through the GUI associated with the timer application running on mobile device 110.

At step 3910, a connection input is received through the GUI to connect to timer display 105. Next, at step 3915 mobile device 110 is connected directly to first timer display 105 using a two-way data communication protocol, such as Bluetooth™. At step 3920, a further connection input is received through the GUI to connect to timer display 3805.

In order to make connection to timer display 3805 possible, at step 3925 mobile device 110 is connected to mobile device 3810 via network 3820. As there can be a communication lag between mobile device 110 and mobile device 3810, at step 3930 the communication lag between mobile device 110 and mobile device 3810 is measured.

In some implementations, the communication lag can be measured by sending a message between mobile device 110 and mobile device 3810, while keeping track of the UTC time when the message was sent (e.g. by mobile device 110) and the UTC time when the message was received (e.g. by mobile device 3810). For example, mobile device records the UTC time at which it send the message to mobile device 3810. Mobile device 3810, in turn, records the UTC time when it receives the message, and the reports back to mobile device 110 the UTC time at which mobile device 3810 received the message. This then, can allow mobile device 110 to measure the lag by obtaining the difference between the UTC time of sending the message and the UTC time when it was received. To obtain a more reliable measure of the communication lag, multiple messages can be sent between mobile device 110 and mobile device 3810, and their respective lags can be measured and averaged.

Returning to method 3900, at step 3935 mobile device 3810 is directly connected to timer display 3805 using the two-way data communication protocol, such as Bluetooth™. At step 3940 the schedule is transmitted from mobile device 110 to timer display 105. The next step is step 3945 shown in FIG. 40. At step 3945 the schedule is transmitted from mobile device 110 over network 3820 to mobile device 3810, and then from mobile device 3810 to timer display 3805. In other words, the schedule is transmitted from mobile device 110 to timer display 3805 via mobile device 3810.

Next, at step 3950 an initial state associated with the schedule is displayed in a paused state on timer display 105 and on timer display 3805. Then, at step 3955, a start input to start counting time according to the schedule is received through the GUI of timer application running on mobile device 110.

Following the receipt of the start input, at step 3960 a modified start input is transmitted from mobile device 110 to timer display 105 and to timer display 3805 via mobile device 3810. The modified start input comprises the start input delayed by a time period equal to or greater than the communication lag. Use of this modified start input can allow both timer display 105 and timer display 3805 to start counting time at the same absolute time (i.e. UTC time) regardless of the communication lag between respective mobile devices 110 and 3810 controlling the two timer displays. In some implementations, a multiple or factor of safety can be applied to the communication lag to arrive at the time period of the delay, to ensure that simultaneous start of the distant timer displays remains possible even if the communication lag in a particular instance exceeds the average calculated communication lag. In some implementations, this factor of safety can comprise a multiple of two or four. For example, if the average lag time is two seconds, the delay time used to arrive at the modified start input can be four or eight seconds.

In some implementations, in order to ensure that both mobile device 110 (and by extension timer display 105) and mobile device 3810 (and by extension timer display 3805) are aware of the modified start input, mobile device 110 and mobile device 3810 continue to attempt to send acknowledgements and confirmations to one another to the effect that they are each aware of and in agreement as to the modified start input. The attempts to send confirmations/acknowledgement can cease if sufficient confirmation is received that both mobile devices are aware of and in agreement about the modified start input. In some implementations, if sufficient confirmation/acknowledgements are not received by the start time designated in the modified start input, a further modified start input can be set to allow the mobile devices additional time to confirm that they are both aware of and in agreement as to the further modified start input. If sufficient time passes without the mobile devices being able to receive the necessary confirmations, an error message can be displayed on both mobile devices to the effect that synchronization was not successful.

At step 3965 timer display 105 and timer display 3805 display time being counted according to the schedule. As such, method 3900 can allow one mobile device 110 to start two sets of timer displays 105 and 3805 to be started at the same absolute time despite the communication lag and/or geographical distance between the respective mobile devices connected to those timer displays.

While system 3800 shows two sets of mobile devices and corresponding timer displays, it is contemplated that any number of sets of mobile devices and their corresponding timer displays can be controlled, and synchronously started, based on the start input received at one of the mobile devices.

While the above description generally describes methods of connecting one timer display to a mobile device, it is contemplated that multiple timer displays can be connected to and controlled by a mobile device running the timer application. When the application timer has not yet been started, the timer displays can one-after-the-other be connected to the mobile device and initialized to the point of displaying on each timer display an initial state associated with the schedule in a paused state. See for example steps 2933 and 3059 in methods 2900 and 3000 respectively. When the start input is received, then the start input is communicated to all the timer displays one-after-the-other, i.e. sequentially. As communicating the relatively short start input is much quicker than communicating the relatively longer schedule to each timer display, initializing multiple timer displays with the schedule before sending the start input to them can reduce any lag between the absolute start times of the various timer displays.

On the other hand, if the start input has been received and the application timer is already counting time according to the schedule, each timer display can be initialized (e.g. by sending the schedule to the timer display) and then started one timer display after the other. Despite the sequential initialization and start times, these timer displays can remain synchronized with one another because the mobile device can send the current time count seed to each timer display to keep each timer display synchronized with the application timer. See for example steps 3225 and 3347 of methods 3200 and 3300 respectively. As each timer is being kept synchronized with the application timer, the timer displays are also kept synchronized with one another.

In some implementations, when one mobile device is connected to and controlling multiple timer displays, each timer display can be loaded and/or initialized with a different schedule, and then all the timers can be started at the same time or nearly at the same time. Generally, when one mobile device is connected to and controlling multiple timer displays running the same schedule, the timer displays can be prevented from drifting from one another, and can be kept synchronized with each other and with the application timer, by transmissions at predetermined intervals of the current time as being counted. These transmissions are affected by the application timer, and are sent from the mobile device to each of the timer displays.

In addition to initializing timer displays and starting the time count according to the schedule, mobile device 110 can also pause and reset timer display 105. In a situation where both the application timer and timer display 105 are both counting time in synchrony according to the schedule, the timer application can present a pause button 1735 and/or a reset button 1740 (as shown in FIG. 17). A pause input can be received through activation of pause button 1735. In response, timer application can pause the application timer, and can also send to timer display 105 the pause input. In some implementations, timer application can send the current elapsed time to timer display 105 along with the pause input.

In response, timer display can pause counting of time, and update its time count to match the current elapsed time of the timer application. In some implementations, timer display 105 can also send a confirmation of receipt to mobile device 110. Next, a reset input can be received through activation of reset button 1740. In response, timer application can reset the application timer, and can also send to timer display 105 the reset input. In response, timer display 105 can rest its time count and, in some implementations, send a confirmation of receipt to mobile device 110.

It is also possible for the timer application to reset timer display 105 when timer display 105 has finished counting time according to the schedule. When timer display 105 finishes counting time, timer application can present reset button 1740, and the reset input can be received through activation of reset button 1740. In response, timer application can reset the application timer, and can also send to timer display 105 the reset input. In response, timer display 105 can rest its time count and, in some implementations, send a confirmation of receipt to mobile device 110.

While the method steps discussed herein are depicted and described in a given order, it is contemplated that those steps can be performed in other suitable orders also.

While the description above focuses on the synchronization of the visual display of the timer display with the visual display of the application timer, it is also contemplated that audio notifications can also be synchronized to the visual displays, and also as between the timer display and the timer application running on the mobile device. For example, a segue countdown can be synched to end immediately before the start of a lap timer schedule.

In addition, when an external speaker, e.g. a Bluetooth™ speaker, is used to generate human-intelligible speech audio notifications, these notifications generated by the speaker can be synchronized with the visual displays of the timer display and the application timer and also with the audio notifications emitted by the buzzer of the timer display. If the speakers are playing music to accompany the exercise schedule being counted on the timer display, the timer application can automatically cooperate with the music application and/or the speakers to lower the volume of the music while buzzer and/or human-intelligible speech notifications are being emitted. This can make it easier for the audio notifications to be heard over the music being played.

In some implementation, the ability to connect to and initialize and/or reset the timer display can be protected by a pass code, to prevent unauthorized interference with the displaying and incrementing/decrementing of the schedule. In some implementations, there can be two classes of pass codes: first, an administrative level pass code that can be used to access and change the operational settings of system 100 (shown in FIG. 1) including connection to timer displays, and audio and visual settings. The second class of pass codes can comprise a user level pass code that can be used to access and change schedule types, prelude, segue, and warnings settings, and heart rate zone presets.

In implementations where such pass codes are in place, connecting the timer display to the mobile device can comprise two stages: at stage one, the mobile device finds and connects to the mobile display. At this point, the communication channel can be considered to be available, but not yet ready. At stage two, the correct pass codes are received, at which point the communication channel can be considered to be ready. Another situation where the communication channel can be available but not ready occurs when the timer displaying is already counting time corresponding to a schedule, and an input to force synch has not been received yet. In both situations, the timer display can track its internal state (e.g. pass code in place and/or actively counting time) and communicate this internal state as part of communicating its status to the mobile device upon connecting to the mobile device. Based on this status received from the timer display, the mobile device can determine whether the communication channel between the mobile device and the timer display is ready.

While the above description focuses on timer displays that are smart in the sense that they can track and report on their own internal states and can also confirm receiving control commands from the mobile device, it is also contemplated that the timer display need not be smart in the sense that the timer display need not be able to track and communicate its internal state and can simply receive commands from the mobile device without being able to communicate back to the mobile device. Such a non-smart timer display can also operate without storing information in memory, and at every moment can simply display the information being sent to it by the mobile device at that moment. Such a non-smart timer display can still receive communicate from the mobile device through a Bluetooth™ protocol.

In addition, the above description generally takes the timer application/mobile device to be the master time and schedule keeper controlling slave timer display(s). However, it is also contemplated that in some implementations timer displays can also act as master schedule keepers instead of or in addition to the mobile device. For example, in some implementations a primary mobile device can initialize and start a timer display. Such a primary mobile device may be operated by a coach in a group exercise class. Once initialized, the timer display can act as a master schedule keeper to initialize secondary mobile devices and to keep those secondary devices synchronized with the timer display. For example, such secondary mobile devices can belong to individual exercisers attending the exercise class.

As discussed above, in system 100 (shown in FIG. 1) the timer application can be used to control timer display 105. The GUI of the application timer can provide a clear and flexible means for selecting and/or configuring exercise schedules, without the need for resorting to complicated IR controller menus and/or numerous IR controller buttons. In addition, one or more of application timer and timer display 105 can provide one or more of visual and audio feedback to show and confirm the schedule currently selected. Functionality of system 100 can also be easily updated by re-programming the timer application without the need for designing and building new hardware.

Moreover, since timer display 105 comprises processors 205 and onboard memory 225 (shown in FIG. 2), timer display 105 is able to continue counting time according to the schedule even if its connection with the mobile device is lost while time is being counted according to the schedule. In some implementations, after reaching the end of a given schedule, timer display 105 reverts to displaying the chronological time. The chronological time can be retrieved from mobile device 110, or can be calculated by the timer display based on a time seed communicated from mobile device 110 to timer display 105 at an earlier time. If no further commands are received from the mobile device for a given period of time (e.g. 15 minutes) timer display 105 can turn off automatically.

In addition, as discussed above, the communications between the mobile device and the timer display can be only intermittent, which can help preserve the battery charge of the mobile device compared to the case where continuous communication between the mobile device and the timer display would be needed. In some implementations, the timer display can also be powered by a battery pack, in which case the intermittency of the communications can also help to preserve the batter charge of the battery pack.

When external sensors and/or wearables are connected to mobile device 110, movement sensed by these sensors can be used as the start input to initiate counting of time according to the schedule. For example, a wireless sensor can be attached to a rowing machine, which sensor may automatically initiate counting of time according to the schedule when the user starts rowing. When external sensors, e.g. sensors embedded in exercise equipment, are used which are capable of providing completed repetitions data, this data can be overlaid on the schedule data to provide a more detailed reflection of an exerciser's performance of repetitions over the time periods specified by the schedule.

In some implementations, timer display 105 can be started, paused, and/or reset using controls presented on a GUI of a wearable device 115, such as a smart watch shown in FIG. 6. Moreover, in system 100, digital selection and/or customization of exercise schedules can make it easy to store and share favorite schedules. In addition, schedules can easily be downloaded from libraries of popular schedules. For example, server 125 (shown in FIG. 1) can host such libraries.

The near real-time communications and the ease of sharing of schedule data can also facilitate gamifying the exercising process. For example, different exercisers and/or home gym users can share and maintain a list of top performances, for example in the form of top times and/or other exercise metrics. Moreover, different gyms can compete with one another by using timer displays to run the same schedule simultaneously. In other implementations, one exerciser can post a time and/or other exercise metric and then challenge another exerciser to match or beat that posted metric at a future time.

In some implementations, multiple mobile devices can be daisy-chained, and used to control a timer display over a distance larger than the range of Bluetooth™ used for direct communication between the timer display and the mobile device connected to it. This system would be similar to system 3800 shown in FIG. 38, with the main difference being that there would be only one set of timer displays. Moreover, in some implementations multiple secondary mobile devices can be in communication with a single primary mobile device which is directly connected to and in control of a timer display.

The above-described implementations are intended to be examples of the present invention and alterations and modifications may be effected thereto, by those of skill in the art, without departing from the scope of the invention which is defined solely by the claims appended hereto.

What is claimed is:

1. A method of communication between a timer display and a mobile device running a timer application, the method comprising:
receiving a selection of a schedule at the mobile device, the selection received through a graphical user interface (GUI) associated with the timer application;
receiving through the GUI a connection input to connect to the timer display;
connecting the mobile device directly to the timer display using a two-way data communication protocol, the timer display comprising a plurality of multi-segment light emitting diode (LED) digits;
transmitting from the timer display to the mobile device a confirmation of connection and a status of the timer display; and
controlling the timer display by the mobile device based on the schedule and the status of the timer display;
after the connecting, the communication between the timer display and the mobile device being in the form of one or more data packets formatted according to the two-way data communication protocol.

2. The method of claim 1, wherein the two-way data communication protocol comprises a wireless communication protocol configured for near real-time, non-line-of-sight communication between the timer display and the mobile device, the communication having a latency less than about 3 s.

3. The method of claim 2, wherein the two-way data communication protocol comprises Bluetooth™.

4. The method of claim 3, wherein the multi-segment LED digits have a height greater than or equal to about 1 inch.

5. The method of claim 1, wherein the status comprises one of:
an unavailability indication associated with the timer display actively counting time or the timer display being paused while displaying non-default start values; and
an availability indication associated with the timer display being in a state other than actively counting time and displaying non-default start values.

6. The method of claim 5, wherein when the status comprises the unavailability indication, the status further comprising a timer display schedule identifier.

7. The method of claim 6, further comprising:
after the connecting and before the transmitting,
the mobile device transmitting to the timer display
a seed for a current chronological clock, and
an audio state and an increment-decrement clock direction associated with the timer application; and
the timer display storing in a memory onboard the timer display the seed, the audio state, and the increment-decrement clock direction.

8. The method of claim 7, wherein the controlling comprises:
if the status comprises the availability indication:
transmitting the schedule from the mobile device to the timer display;
storing the schedule in the memory;
displaying on the timer display an initial state associated with the schedule in a paused state;
receiving through the GUI a start input to start counting time according to the schedule;
transmitting the start input from the mobile device to the timer display; and
displaying on the timer display time being counted according to the schedule and the increment-decrement clock direction; and
if the status comprises the unavailability indication:
displaying a prompt on the mobile device requesting input whether to force synch the timer display with the timer application, the prompt displayed through the GUI associated with the timer application;
receiving through the GUI a force synch input in response to the prompt; and
if the force synch input is affirmative:
transmitting from the mobile device to the timer display a request to pause and reset the timer display;
pausing and resetting the timer display;
transmitting the schedule from the mobile device to the timer display;
storing the schedule in the memory;
displaying on the timer display the initial state associated with the schedule in a paused state;
receiving through the GUI the start input to start counting time according to the schedule;
transmitting the start input from the mobile device to the timer display; and
displaying on the timer display time being counted according to the schedule and the increment-decrement clock direction; and
if the force synch input is negative:
disconnecting the mobile device from the timer display.

9. The method of claim 8, wherein the displaying on the timer display time being counted further comprises emitting one or more sounds from the timer display according to the schedule and the audio state.

10. The method of claim 8, further comprising
after displaying on the timer display time being counted according to the schedule and the increment-decrement clock direction
transmitting at predetermined intervals from the mobile device to the timer display a current time as being counted by the timer application to keep the timer display synchronized with the timer application.

11. The method of claim 10, where the predetermined intervals each comprises about 60 seconds.

12. The method of claim 7,
wherein the method further comprises, after receiving the selection of the schedule and before receiving the connection input:
receiving through the GUI a start input to start counting time according to the schedule; and
displaying on the mobile device time being counted by the timer application according to the schedule; and
wherein the controlling comprises:
if the status comprises the availability indication:
transmitting the schedule from the mobile device to the timer display;
storing the schedule in the memory;
transmitting a current time count seed from the mobile device to the timer display, the transmitting affected at a predetermined lead time prior to a smallest time increment displayable on the timer display; and
displaying on the timer display time being counted starting at the current time count seed and according to the schedule and the increment-decrement clock direction; and
if the status comprises the unavailability indication:
displaying a prompt on the mobile device requesting input whether to force synch the timer display with the timer application, the prompt displayed through the GUI associated with the timer application;
receiving through the GUI a force synch input in response to the prompt; and
if the force synch input is affirmative:
transmitting from the mobile device to the timer a request to pause and reset the timer display;
pausing and resetting the timer display;
transmitting the schedule from the mobile device to the timer display;
storing the schedule in the memory;
transmitting the current time count seed from the mobile device to the timer display, the transmitting affected at the predetermined lead time prior to the smallest time increment displayable on the timer display; and
displaying on the timer display time being counted starting at the current time count seed and according to the schedule and the increment-decrement clock direction; and
if the force synch input is negative:
disconnecting the mobile device from the timer display.

13. The method of claim 12, wherein the predetermined lead time comprises about 10 ms and the smallest time increment displayable by the timer display comprises about 1 s.

14. The method of claim 7,
wherein the method further comprises, after receiving the selection of the schedule and before receiving the connection input:
receiving through the GUI a start input to start counting time according to the schedule; and
displaying on the mobile device time being counted by the timer application according to the schedule; and
wherein the controlling comprises:
if the status comprises the availability indication:
transmitting the schedule from the mobile device to the timer display;
storing the schedule in the memory;
transmitting a current time count seed from the mobile device to the timer display, the transmitting affected at a predetermined lead time prior to a smallest time increment displayable on the timer display; and
displaying on the timer display time being counted starting at the current time count seed and according to the schedule and the increment-decrement clock direction; and
if the status comprises the unavailability indication:
comparing at the mobile device the timer display schedule identifier received from the timer display with a timer application schedule identifier stored on the mobile device to determine whether the timer display and the timer application are counting time in synch and according to the schedule;
if the timer display schedule identifier is the same as the timer application schedule identifier:
the mobile device remaining connected to the timer display; and
if the timer display schedule identifier is different than the timer application schedule identifier:
displaying a prompt on the mobile device requesting input whether to force synch the timer display with the timer application, the prompt displayed through the GUI associated with the timer application;
receiving through the GUI a force synch input in response to the prompt; and
if the force synch input is affirmative:
transmitting from the mobile device to the timer a request to pause and reset the timer display;
pausing and resetting the timer display;
transmitting the schedule from the mobile device to the timer display;
storing the schedule in the memory;
transmitting the current time count seed from the mobile device to the timer display, the transmitting affected at the predetermined lead time prior to the smallest time increment displayable on the timer display; and
displaying on the timer display time being counted starting at the current time count seed and according to the schedule and the increment-decrement clock direction; and
if the force synch input is negative:
disconnecting the mobile device from the timer display.

15. The method of claim 1, further comprising:
after the transmitting and before the controlling:
transmitting the schedule from the mobile device to the timer display;
storing the schedule in a memory onboard the timer display;
displaying on the timer display an initial state associated with the schedule in a paused state;
receiving through the GUI another selection of another schedule;
transmitting the other schedule from the mobile device to the timer display;
storing the other schedule in the memory; and
displaying on the timer display an initial state associated with the other schedule in a paused state;
wherein the controlling the timer display by the mobile device comprises controlling the timer display by the mobile device based on the other schedule and the status of the timer display.

16. The method of claim 1,
further comprising, before the controlling:
receiving through the GUI an input to display sensor data on the timer display for a given display duration at one or more predetermined display times; and
wherein the controlling comprises:
at each predetermined display time
receiving the sensor data at the mobile device;
transmitting the sensor data from the mobile device to the timer display;
clearing one or more portions of the timer display needed to display the sensor data; and
displaying the sensor data on the timer display for the given display duration.

17. A timer display comprising:
a plurality of multi-segment LED digits having a height greater than or equal to about 1 inch;
a sound generator;
a processor configured to drive the multi-segment LED digits and the sound generator;
a memory in communication with the processor; and
a communication interface in communication with the processor, the communication interface configured for two-way data communication;
the timer display configured to:
connect directly to a mobile device running a timer application, the connection via the communication interface and using a two-way data communication protocol;
receive a schedule from the mobile device via the communication interface, the schedule received in the form of one or more data packets formatted according to the two-way data communication protocol, a selection of the schedule received through a GUI associated with the timer application;
store the schedule in the memory;
transmit via the communication interface to the mobile device a confirmation of connection and a status of the timer display, the confirmation and the status transmitted in the form of one or more data packets formatted according to the two-way data communication protocol;
receive via the communication interface one or more control commands from the mobile device, the control commands in the form of one or more data packets formatted according to the two-way data communication protocol; and
control via the processor one or more of the multi-segment LED digits and the sound generator according to the control commands.

18. The timer display of claim 17, wherein the two-way data communication protocol comprises a wireless communication protocol configured for near real-time, non-line-of-sight communication between the timer display and the mobile device, the communication having a latency less than about 3 s.

19. The timer display of claim 18, wherein the two-way data communication protocol comprises Bluetooth™.

20. A method of communication between a first mobile device running a timer application, a first timer display, a second mobile device running the timer application, and a second timer display, the method comprising:
receiving a selection of a schedule at the first mobile device, the selection received through a GUI associated with the timer application running on the first mobile device;
receiving through the GUI a connection input to connect to the first timer display;
connecting the first mobile device directly to the first timer display using a two-way data communication protocol;
receiving through the GUI a further connection input to connect to the second timer display;
connecting the first mobile device to the second mobile device;
measuring a communication lag between the first mobile device and the second mobile device;
connecting the second mobile device directly to the second timer display using the two-way data communication protocol;
transmitting the schedule from the first mobile device to the first timer display;
transmitting the schedule from the first mobile device to the second timer display via the second mobile device;
displaying on the first timer display and the second timer display an initial state associated with the schedule in a paused state;
receiving through the GUI a start input to start counting time according to the schedule;
transmitting a modified start input from the first mobile device to the first timer display and to the second timer display via the second mobile device, the modified start input comprising the start input delayed by a time period equal to or greater than the communication lag; and
displaying on the first timer display and the second timer display time being counted according to the schedule.
